(19) United States
(12) Patent Application Publication
(10) Pub. No.: US 2008/0027783 A1
(43) Pub. Date: Jan. 31, 2008

(54) System and method for staffing and rating

(76) Inventors: John M. Hughes, Hebron, CT (US); Jarrod Paquette, Sagamore Beach, MA (US); John Paquette, Sagamore Beach, MA (US); Andrew Lamora, Philadelphia, PA (US)

Correspondence Address: GOODWIN PROCTER LLP;PATENT ADMINISTRATOR, EXCHANGE PLACE, BOSTON, MA, 02109-2881, US

(21) Appl. No.: 11/809,789

(22) Filed: Jun. 1, 2007

Related U.S. Application Data
(60) Provisional application No. 60/812,363, filed on Jun. 9, 2006.
(60) Provisional application No. 60/810,621, filed on Jun. 2, 2006.

(51) Int. Cl. G06Q 10/00

(52) U.S. Cl. 705/9; 705/7

(57) ABSTRACT

In one embodiment, a method and system for staffing and rating workers is able to match hiring entities with rated workers with skills and experience suitable for their needs. In one such embodiment, self-service tools allow the workers and hiring entities to manage matching transactions without administrative action. In one embodiment, the system provides metrics for rating the workers based on their professionalism and reliability, and gives hiring entities the ability to select workers according to this rating.

### CROSS-REFERENCE TO RELATED APPLICATIONS

This application claims priority to U.S. provisional patent application Ser. No. 60/810,621, filed on Jun. 2, 2006 and U.S. provisional patent application Ser. No. 60/812,363, filed on Jun. 9, 2006, the entire disclosures of which are incorporated herein by reference.

### BACKGROUND

Many companies struggle to maintain sufficiently staffed and well-trained workforces. Although temporary agencies attempt to full this need, the process for finding, hiring and compensating workers is inefficient. For example, in agency nursing, hospitals, nursing homes and other facilities telephone or fax a nursing agency to find an appropriately licensed nurse to fill a temporary need. Agency workers, in turn, typically make telephone calls to nurses to locate a fit. In addition, nurses themselves typically vary widely in professional ability and reliability, and agencies often do not receive any feedback regarding the nurses' performance.

### SUMMARY

In general, the invention provides methods, systems and an online marketplace for workers and the consumers of the workers' services (e.g., service providers and hiring entities) that include intuitive, online, automated tools to help manage the relationship between the workers and the hiring entities. In the context of healthcare, as just one possible example, the invention may be used to match nursing professionals with suitable shifts and/or long term positions at hospitals, doctor's offices, clinics and other healthcare facilities. The invention also provides screening capabilities such as administering tests to prospective workers (especially professional workers, licensed workers, or other skilled workers) to ensure they meet certain minimum aptitude thresholds. As such, the hiring entities can be confident that the workers they employ have the skills necessary to perform the job being advertised. In addition, hiring entities may submit evaluations of the workers, and based on the evaluations, the professionalism and quality of the worker can be rated. These ratings can then be used to identify particularly skilled and professional workers who may, in turn, demand higher rates and gain access to additional employment opportunities.

In one aspect, a method for providing workers to fulfill staffing requests includes receiving availability information from a worker that has a reliability rating and a professionalism rating, and generating a composite rating from the reliability rating and the professionalism rating. A shift staffing request is received from a hiring entity, and the worker's availability is matched with the hiring entity's shift staffing request using the first composite rating. Once the shift is complete, an evaluation of the worker is received from the hiring entity and a subsequent reliability rating and professionalism rating is calculated based on the evaluation and the worker's previous ratings, from which a new composite rating can be calculated.

In one embodiment, the worker may be a health care worker, such as a Nurse (e.g. Nurse Practitioner (“NP”), Registered Nurse (“RN”), Licensed Practical Nurse (“LPN”), Licensed Vocational Nurse (“LVN”), Certified Nurse's Assistant (“CNA”), and/or a Health Care Aide (“HCA”)). In such cases, the hiring entity may be a health care provider such as a hospital, nursing home, or other facility, or a private residence. A hiring entity may authorize an individual to act as a manager who can perform administrative tasks within the system on behalf of the hiring entity.

The availability information may include dates, days of the week, and/or times that the worker is available or willing to work, a preferred geographic location and/or a minimum travel distance. In some instances, the method also includes collecting registration information from the worker, such as a name, email address, phone number, licensure information, union membership information, skills, previous work history, and similar information. In some cases, the registration information may include a preferred method of communication (e.g., email, cell phone). In some implementations, the matching process may also be based on the workers' skills, skill level, number of years using the skill and/or how recently the skill or skills were used.

In some embodiments, the workers may be screened prior to being considered for the matching process. The screening may include the administration of one or more tests aimed at gauging the worker's knowledge of a particular subject area and/or skill. In the nursing context, as just a few of the many possible examples, the tests may require the workers to identify certain drug interactions, recite the process for administering an intravenous drip, or calculate dosages.

In some cases, timesheet data may be collected from the worker and/or the hiring entity and submitted for review and payment. In some instances, the timesheet data may influence the ratings, in that timesheets indicating a worker arrived late for a shift may cause a reduction in the worker's reliability rating. In some cases, the timesheets must be approved by the hiring entity prior to payment. Timesheets and/or evaluations may be appealed in instances in which a worker or hiring entity disagrees with an entry, rating and/or comment.

In some embodiments, points are awarded for working shifts, and may be deducted for tardiness, for canceling and/or for missing shifts. Workers may also receive an evaluation of their skills based on surveys completed by the hiring entities. A worker may be rated once for each shift worked, for example, or for every two weeks working at the same facility. A composite rating score may be generated by combining reliability rating and professionalism rating. In some embodiments, the reliability and/or professionalism ratings may be weighted such that one has a greater influence on the composite rating than the other.

In another aspect of the invention, the methods and techniques described above are implemented using a web-based system that facilitates matching workers with shifts based on availability, skills, and ratings. The system also allows users to communicate with administrators, participate in online community features, as well as other functions. The system may also include automated payroll processing features that address withholding, taxes and/or benefits. The system may include personalized secure areas for workers (in the exemplary implementation, nursing professionals), hiring entities, and for administrators to accomplish the tasks described herein. In one embodiment, the system also includes a public area to communicate news, marketing, and demonstrations, and enables the development of an online community for workers to freely interact.

In one embodiment, the system matches hiring entities to rated workers that have the skills and experience suitable for the advertised needs. In one such embodiment, system allow the workers and hiring entities to manage matching transactions without administrative action. In one embodiment, the system provides metrics for rating the workers based on their professionalism and reliability, and gives hiring managers the ability to select workers according to this rating. In one embodiment, the workers indicate a minimum price for which they are willing to work, and any excess offered by the hiring entity over such minimum is given to the worker, after subtracting taxes and in some cases certain fees to the system administrators. In another embodiment, excess over the worker's minimum is divided between the worker and the hiring entity, after subtracting taxes and fees.

The foregoing and other objects, features and advantages of the present invention disclosed herein, as well as the invention itself, will be more fully understood from the following description of preferred embodiments and claims, when read together with the accompanying drawings.

### BRIEF DESCRIPTION OF THE DRAWINGS

FIG. 1 is an exemplary illustration of how parties interact with and utilize a workforce marketplace according to one embodiment of the invention.

FIG. 2 is a flowchart of a method according to an embodiment of the invention.

FIG. 3 is a screen display for the registration of a provider according to an embodiment of the invention.

FIG. 4 is a further exemplary screen display for the registration of a provider according to an embodiment of the invention.

FIG. 5 is a further exemplary screen display for the registration of a provider according to an embodiment of the invention.

FIG. 6 is an exemplary screen display for the registration of a professional according to an embodiment of the invention.

FIG. 7 is a further exemplary screen display for the registration of a professional according to an embodiment of the invention.

FIG. 8 is an exemplary display for editing profile information of a user according to an embodiment of the invention.

FIG. 9 is an exemplary calendar display for a provider according to an embodiment of the invention.

FIG. 10 is an exemplary day view for a provider according to an embodiment of the invention.

FIG. 11 is an exemplary calendar display for a professional according to an embodiment of the invention.

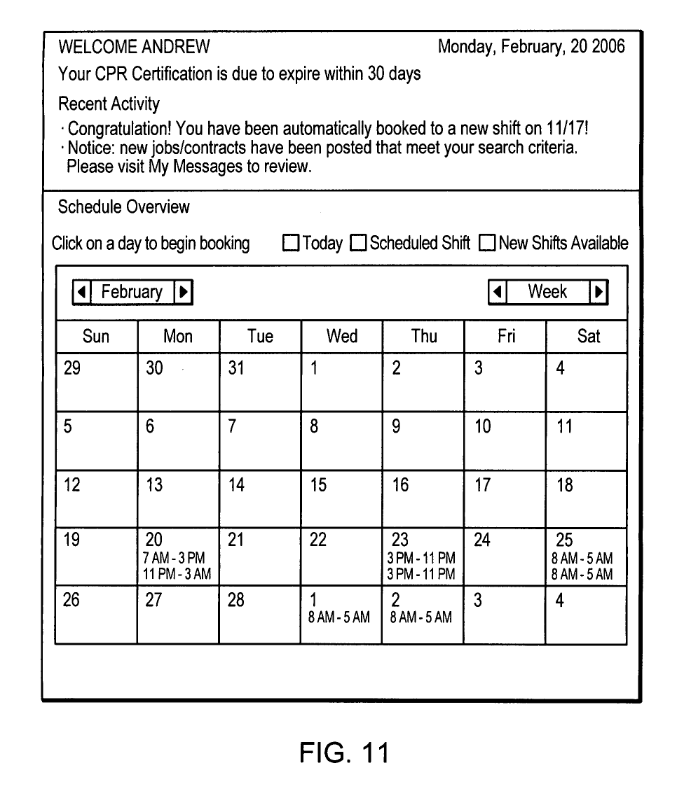

FIG. 12 is an exemplary display for designating shift availability for a professional according to an embodiment of the invention.

FIG. 13 is an exemplary display for viewing shifts according to an embodiment of the invention.

FIG. 14 is an exemplary further display for listing saved shift preferences for a professional according to an embodiment of the invention.

FIG. 15 is an exemplary display for specifying block lists and short lists by a provider according to an embodiment of the invention.

FIG. 16 is an exemplary display for specifying a QuickAdd by a provider according to an embodiment of the invention.

FIG. 17 is an exemplary display for specifying shifts by a provider according to an embodiment of the invention.

FIG. 18 is an exemplary further display for specifying shifts by a provider according to an embodiment of the invention.

FIG. 19 is an exemplary display for viewing shift responses by a provider according to an embodiment of the invention.

FIG. 20 is an exemplary display for viewing shifts by a professional according to an embodiment of the invention.

FIG. 21 is an exemplary display for viewing shifts by a provider according to an embodiment of the invention.

FIG. 22 is an exemplary timesheet display for completion by a professional according to an embodiment of the invention.

FIG. 23 is an exemplary timecard information display for approval by a provider according to an embodiment of the invention.

FIG. 24 is an exemplary evaluation display for completion by a provider according to an embodiment of the invention.

FIG. 25 is an exemplary evaluation display for review by a professional according to an embodiment of the invention.

FIG. 26 is an exemplary appeal form for completion by a professional according to an embodiment of the invention.

FIG. 27 is an exemplary reliability display for review by a professional according to an embodiment of the invention.

FIG. 28 is an exemplary rating display according to an embodiment of the invention.

FIG. 29 shows demonstrative examples of the values for the rating display of FIG. 27.

FIG. 30 shows a block diagram of a system according to an embodiment of the invention.

### DETAILED DESCRIPTION

In general, the invention provides methods and systems for registering, staffing, evaluating and rating members of a workforce. Such techniques can be used to find and recruit professionals, skilled labor, and/or unskilled labor to fill temporary and/or permanent positions in a manner that meets the needs of both the workers and the entities looking to hire them. More specifically, workers may be provided with access to more employment opportunities, performance-based pay and control over their schedule, while at the same time the hiring entities may gain such benefits as access to a larger pool of potential workers (which in some cases may be prescreened for or identified as an expert in a particular field or specialty), a better understanding of the rates at which the workers should be compensated, and access to performance and reliability ratings based on the workers' previous engagements. As a result, the invention greatly improves the efficiency of the labor market and workers that provide exceptional services and display outstanding reliability may enjoy increased compensation. Furthermore, because the workers can see their evaluations and ratings, they are encouraged to expand their skills and improve their service delivery and reliability such that they are in greater demand. Automated matching, messaging, and shift fulfillment also allows the system to find and staff workers for unfilled shifts without requiring the parties to constantly monitor and review job opportunities and workforce availability.

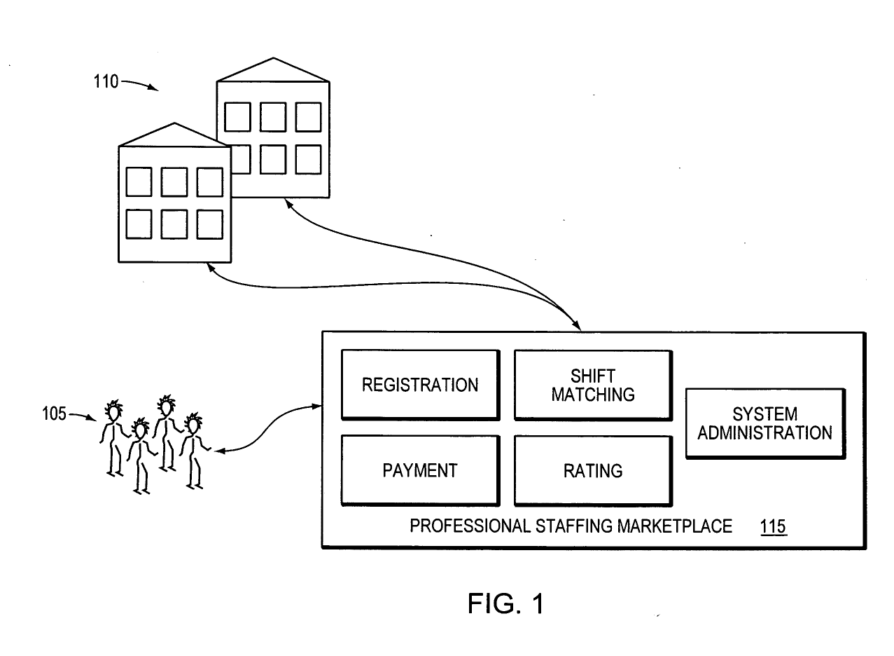

FIG. 1 illustrates one exemplary environment in which embodiments of the invention may be implemented. A community of workers 105 and one or more hiring entities 110 interact with each other through a professional staffing marketplace 115. Although embodiments are described with respect to systems and techniques for matching healthcare workers with hospitals, clinics and/or doctor's offices that have a need for nurses, technicians and other similarly skilled professionals, the staffing marketplace 115 may be used in any context in which workers and potential hiring entities benefit from such a system. The community of workers 105 may include unskilled laborers (e.g., movers, agricultural workers, deckhands, foodservice workers, etc.), security personnel, teachers, lawyers, accountants, construction workers, and/or virtually any type of temporary worker. The workers may be in the same or different geographic areas. The hiring entities 110 looking to hire the workers may be any type of company, organization, group, family, individual or municipality that have a need to fill temporary (or even permanent) positions. There may be one, two or many different hiring entities. The marketplace 115 provides various services and functions for both the workers 105 and the entities 110 such as registration, shift matching, payment and evaluation and rating, as well as various functions that may be used by system administrators to operate and monitor the marketplace 115. As such, the marketplace 115 operates as a “virtual broker” between the workers 105 and the entities 110 facilitating easy communications among the parties and simultaneously creating an efficient market for the workers' services.

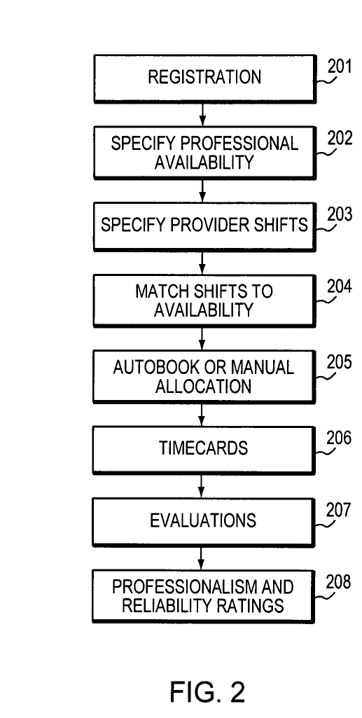

In general, FIG. 2 illustrates one embodiment of the invention that includes the following steps. A registration step (STEP 201) allows users (e.g., both workers and individuals representing hiring entities) to register as users of the system and indicate which role (or roles) they will assume and to indicate general preferences regarding the types of work to be provided or requested. An availability specification step (STEP 202) provides workers with the ability to define and manage their preferred work schedule and load. During the shift specification step (STEP 203), entities needing to fill open shifts provide various parameters regarding the shifts (by date/time, function, cost, or other parameters), and a matching step (STEP 204) finds workers that have availability during a requested shift and are willing and/or able to provide the service. A booking/allocation step (STEP 205) confirms the match, assigns the worker (or workers) to the shift and provides any additional information (e.g., location, contact person, etc.). A timekeeing step (STEP 206) manages the receipt of timecards and payment of the workers, including, in some cases, withholding, taxes and so forth. An evaluation step (STEP 207) and a rating step (STEP 208) allow the entities to provide an evaluation of the workers' performance, and based on the evaluation (an in some cases previous evaluations) rate the worker. Each step and the options and variations of each is described in greater detail below.

General Overview of an Embodiment

Once registered (STEP 201), users may login to the system and use the functions of the marketplace. Workers may specify their availability (STEP 202). This may involve performing searches and/or registering availability with the system. Workers may indicate that they wish to use an “autobook” feature (described in greater detail below), which facilitates the automatic assignment of a shift (or a series of shifts) if the workers have availability and other constraints are met (e.g., licensure, minimum reliability ratings, minimum professional ratings, hourly rates, etc.). In one embodiment, workers must complete a designated number of shifts to receive a reliability rating and a professionalism rating.

Entities may specify shifts for which they require staffing (STEP 203). This may involve specifying the skills, certifications, and licenses required, as well as a price that the entity is willing to pay. In some cases, the price the entity is willing to pay may depend on the ratings and/or certifications of the workers responding to or being scheduled for the shifts. The shifts may be individual shifts (e.g., May 20%, 8:00 AM to 4:00 PM), or the shifts may be recurring (every Tuesday and Thursday from midnight to 8:00 AM). Recurring shifts may have end dates (e.g., through Dec. 31, 2007) or continue until cancelled.

The system matches workers' availabilities with the shift staffing requests. (STEP 204). This may involve identifying the best matches of workers who have availability during those shifts and meet the requested qualifications. In one embodiment, if the hiring entity requests an immediate match and a qualified worker has selected the “autobook” feature, the worker is automatically staffed on the shift. (STEP 205) In some embodiments, the system determines which worker to staff if there is more than one available qualified worker. For example, the system may select the worker with the best rating, the worker with the most extensive qualifications, the worker willing to work for the lowest pay, the worker within some geographic area, or some combination thereof. The selection may be based on a weighed combination of the reliability rating and the professionalism rating (a “composite rating”), which may be generated.

If none of the available workers have selected the “autobook” option, workers meeting the qualifications of the shift request may be, in some embodiments, notified of the shift (by email, for example), and the first worker to respond and agree to take the shift may be staffed. In some embodiments, if none of the workers have stated a willingness to work at the requested price, qualified workers may be notified and asked to work at the specified price and/or asked to reduce their asking price by some amount (e.g., half the difference between their price and the price offered by the hiring entity).

Following completion of the shift, the worker's timecard can be submitted to the system and approved (STEP 206). The entity for which the worker completed the shift may then evaluate the worker's performance from a professional standpoint (e.g., the worker had sufficient knowledge or skills to perform the task) and/or from a reliability standpoint (the worker showed up on time, worked the entire shift, etc.). (STEP 207). In some cases, the worker has the ability to review and challenge the evaluation. For example, if the worker does not agree with a particular aspect of the evaluation (she believed she was on time, or the job required skills not requested in the shift request) she may to appeal the evaluation, which if successful may result in the evaluation not being included in her rating and/or may result in an adjustment to the rating. Following acceptance of the timecard and the evaluation, the ratings for the worker are updated. (STEP 208) The ratings may be displayed with the user's profile, and may be used in the allocation of future shifts. Each of the steps outlined above are discussed in greater detail below.

Registration

To participate in the staffing marketplace, users may register with the system. Users, as used herein, refer to individuals interacting with the staffing marketplace in one or more roles such as a worker looking for employment, representatives of hiring entities (such as an HR manager, accounting staff member, supervisor, or staffing specialist) or administrative users acting on behalf of the marketplace itself to provide technical and administrative assistance to other users. The registration process may involve many steps, and in some embodiments may involve taking screening tests, answering surveys, providing references, confirming employment and/or education history, confirming licensure status, providing documents, and/or executing contracts. Some of the registration steps may be performed using the system, and some may be performed manually using paper documents, mail and/or in person interviews.

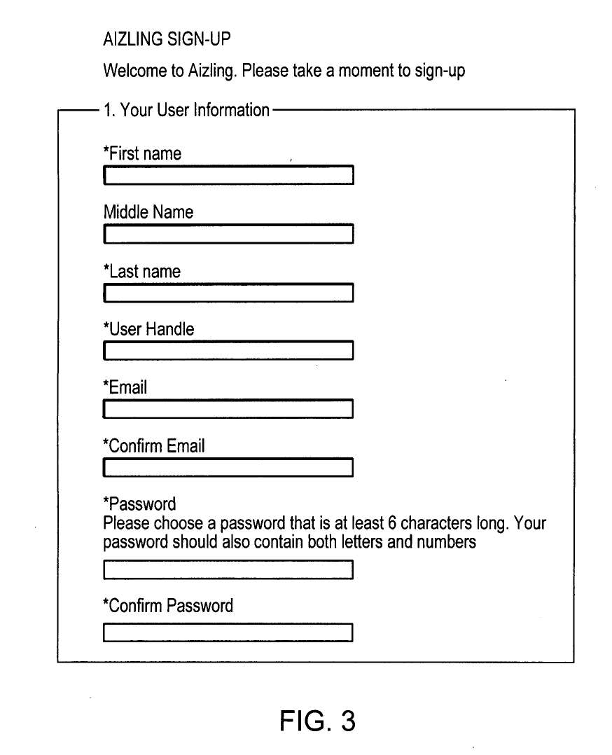

Referring to FIG. 3, in one embodiment, a user begins registration by filling out a registration form 300. The registration form may include one or more text boxes, drop-down boxes or other data entry fields to capture user information such as first and last name, a unique user name (also referred to as a “handle”), an email address and a password. Once the user enters the data, it can be verified for uniqueness and/or form, and the email address can be tested to assure viability.

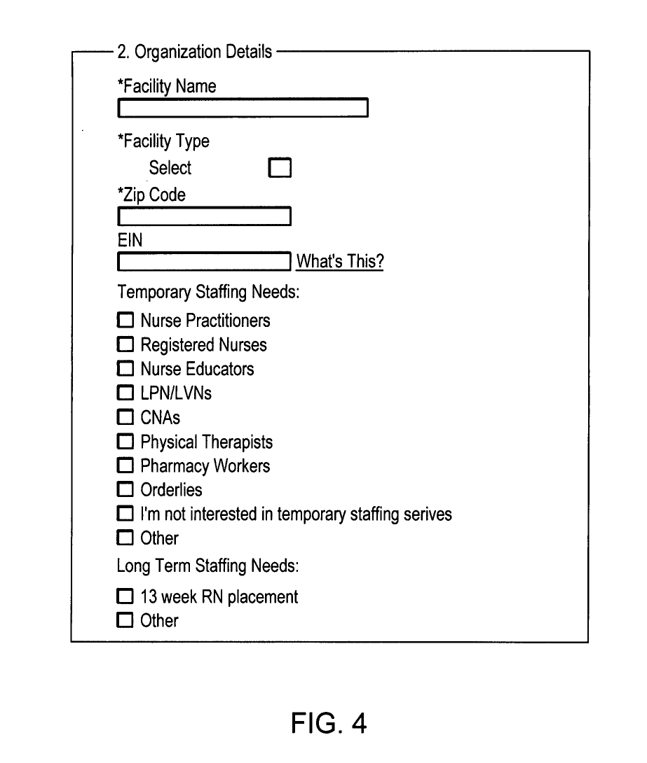

Prior to or during the registration process, a user may indicate whether they represent a hiring entity (e.g., a healthcare provider facility or organization that will be requesting workers through the marketplace) or that they are a worker looking to be hired. FIG. 4 depicts an exemplary entity registration screen 400 at which a user representing a hiring entity may provide a name and type of facility they represent (e.g., hospital, clinic, doctor's office, individual, etc.). In some embodiments, the user also provides demographic information (e.g., a zip code, city, or other geographic data) such that the system can identify workers willing to work in the location and/or within a certain area of the facility. In some embodiments, the system may calculate the distance between the hiring entity and certain workers. In certain implementations, the hiring entity may also utilize the system to manage payments to the workers, including, for example, tax payments, withholding, social security, benefits, etc. In such cases, it may be necessary for the user to provide an employer identification number (EIN) so the system can submit taxes and other withheld funds to various governmental agencies, such as the U.S. Internal Revenue Service and state authorities. A user may also enter one or more types of services for which they have a need (e.g., in this example, Nurse Practitioners, Registered Nurses, Nurse Educators, LPN/LVNs, CNAs, Physical Therapists, Pharmacy Workers, and Orderlies). A user may indicate whether there are types of longer term services of interest.

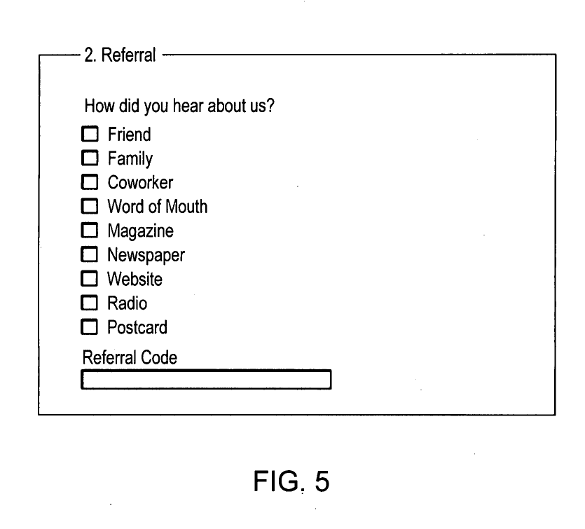

Referring to FIG. 5, the user may complete a referral form that includes information about how they became aware of the marketplace 115 such that the administrators of the marketplace can track how use of and interest in the marketplace is spreading. The referral information may include a referral source, which may be checkboxes or other indicator of a referral source, such as, in this example, friend, family, coworker, word of mouth, magazine, newspaper, webpage, radio, postcard and so forth. The referral information also may include a code, such as a code received on-line or through the mail via a solicitation notice.

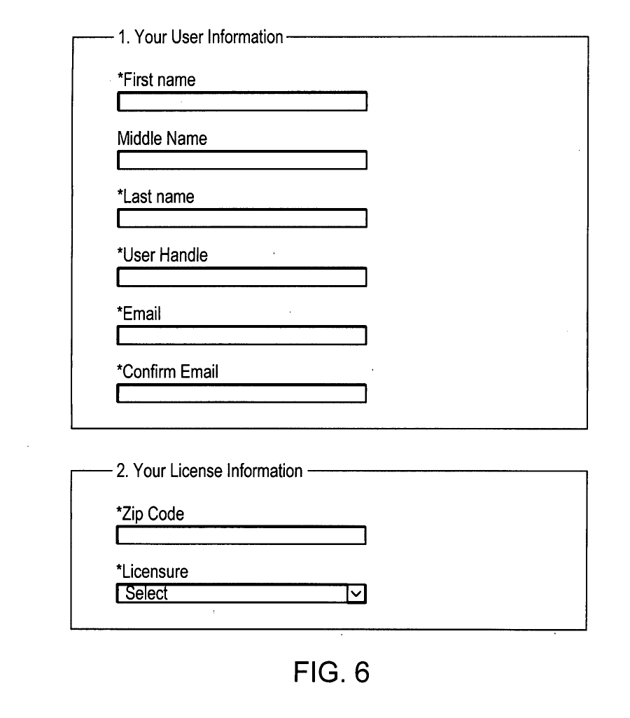

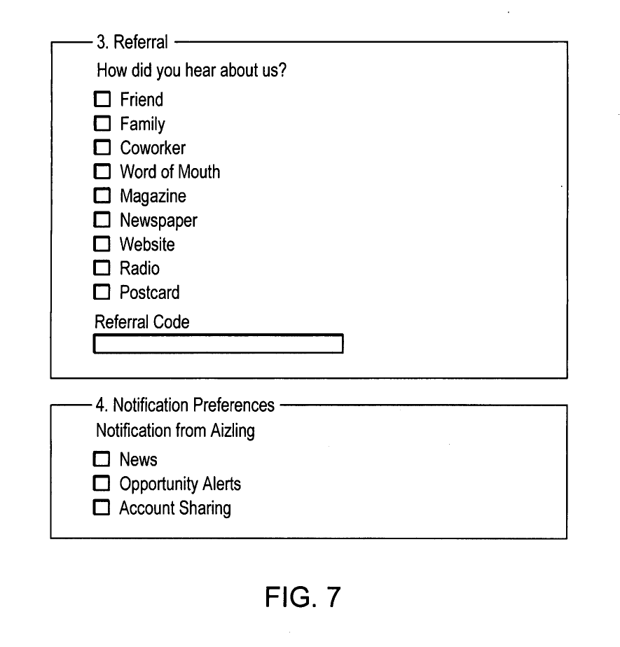

Referring to FIG. 6, users registering as a professional or other worker looking for employment opportunities can provide a name, handle, email and certain demographic information. In implementations in which the types of jobs being offered and/or requested require licensing, the worker may also provide licensure information, such as the location and type of license, when the particular license was issued, when it expires and the board and/or municipality that issued the license. In some instances, licensure information of the workers is requested and received, however it may not be required. In some cases, additional membership information may also be captured, such as union membership, professional organizations, etc. Referring to FIG. 7, the worker may also provide referral information, as well as notification preferences, indicating the type, format, method and/or frequency they wish to be contacted.

Following registration, an account is created for the user. For example, an email may be sent to the email address provided during registration confirming certain information and requesting the user visit a website to confirm their intentions to register. In one embodiment, the user receives a confirmation email such as the following during the registration process.

Subject: Professional Account Setup
GREETINGS!
You are receiving this message because your email address was
provided during the registration of a new account at <web address>.
If have not visited our site, and this email is a surprise to you, please
be aware that somebody might be using your address without your
knowledge. To address the problem we suggest you contact your
Internet Service Provider.
Otherwise, please click on the link below to complete your registration.
Note, your REGISTRATION IS NOT COMPLETE until you have
finished this step!
http://<web address> /?code=################################
If you have any questions or need assistance, please email
<email address>
Thank You,
The Team

Upon completion of the registration process, the user may receive a confirmation email, such as the following:

Subject: Registration Complete
Congratulations!
Your Registration is complete. Thank you for joining us!
If you have any questions or need assistance, please email
<email address>
Sincerely,
The Team

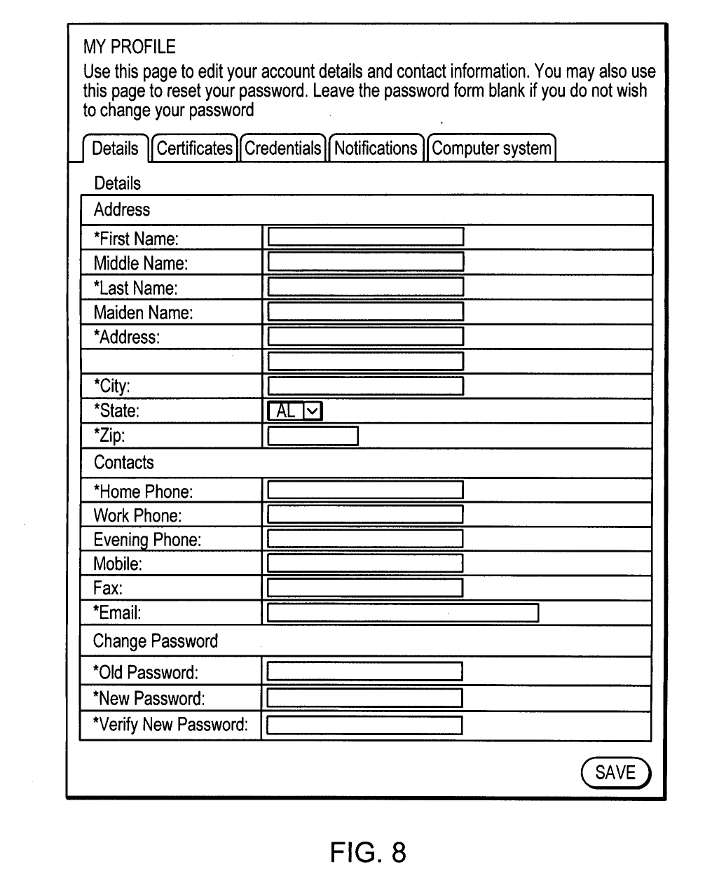

Once registered, users (both workers and hiring entities) may configure their account, modify certain preferences, set up subordinate accounts, set up “QuickAdds” (described below) send and receive messages, and generally utilize the various functions of the marketplace. In implementations in which additional information is needed to verify workers are qualified and/or licensed to perform the jobs being posted, users complete an application and any necessary requirements (e.g., a signed contract), providing proof of licensure, training, references and so on. Referring to FIG. 8, users may update their profile information at any time. For workers, this information may include contact information, credentials, certificates and links to benefits resources. This profile information may be kept separately from schedule and shift management information.

Credential information may include such items as the type of credential or skill, a subcategory of a specialized skill within the selected broad category, a short description of the skill, the number of years experience that the worker has with that skill, and the years since the worker's most recent use of the skill (e.g., currently using this skill, in the past 6 months, in the past year, in the last 2 years, over 2 years ago). Certificates information may include, for example, for a nurse, expiration date of nursing license, expiration date of CPR certification, expiration date of TB immunization, expiration date of current physical and/or date of Hepatitis B Immunization.

In one embodiment, workers complete a knowledge survey test as part of the application process. In one embodiment, although there is no failing grade, tests are scored and may be used to gauge the skill and/or knowledge level of the worker. The scores may be posted, such that entities looking to fill job and/or shift openings can see which workers have achieved the best scores. Scores can be either a raw score (e.g., the number of correct answers divided by the total number of questions) or a scaled score that considers the scores of other workers. In some cases, the scores are not posted, but instead are translated to an icon or other visual indicator of the score. For example, those scoring in the top 20% of all test takers earn a blue badge for their ratings portfolio and those in the next 20% earn the same badge, in red. Workers may be invited or asked to retake a test periodically, for example upon the expiration of a license, the introduction of new technology, or when requesting to be considered for new or different jobs.

In one embodiment, tests are multiple-choice and provided by and automatically graded by the system. In some instances, the questions may require short answers, in which case administrators may review and score the tests. The questions may be compiled from generally known information obtained from textbooks, web sites, published papers, product specifications or written specifically for the system by the administrative staff managing the marketplace. The user taking the test may be provided with her final score, and/or in some cases the average scores of others taking the score, which in some cases may be further segmented by demographic data and/or experience level.

In one embodiment, in order to begin working shifts, registered workers first complete and submit an application and/or the above mentioned tests. The application may include information that can be gathered online, and documentation that workers send by mail, for example, for regulatory reasons.

In one embodiment, workers provide application information on-line. This information may include personal information, reference information, and the like.

In one embodiment, the system determines whether all of the application information has been provided (e.g., contact details, licensure information, credential information, expiration dates for certifications, personal references, work references, and whether the survey tests have been completed). In one embodiment, when the online information is complete, the worker is sent a checklist of additional information to be provided by mail. An exemplary notice is provided below:

Subject: Application Received!
Dear xxx,
Thank you for submitting your application!
You're just about there, but there are a few more steps to take before we
can complete your application. These steps are described below:
1. Print the checksheet list provided when you completed your
application (we are including another copy for you here with
this email)
2. Photocopy the documents included in the list
3. Sign and date the Checklist
4. Put them all in an envelope, and send them to us!
Our Address:
<address>
Thank you again!
The Team

In one embodiment, hiring entity managers may establish additional accounts that are subordinate to their own. Each account may be granted roles to govern access permissions for use of a portal used to view information relating to that entity's use of the system. The roles and permissions of the subordinate accounts that are assigned to their main account may be updated, deleted and added at any time.

For example, hiring entities may create a finance account that permits users logged in under that account to view payment data, but not information about specific workers. Because larger organizations, such as hospitals may use staffing offices to handle accounting, such entities may create a role that has access to billing information, but not to features related to setting, finding, or rating workers, or to posting shifts. Also, because the staffing office might be located in a different department or physical location than where the worker will complete the shift, the contact information for the staffing office may be different than that associated with the manager account.

In the nursing context, for example, for an entity that is a health care facility, hospital or private party a default manager account may have full access and may be used to assign one or more roles for other accounts, which may be configured to accommodate a typical hospital HR process as an overall owner of the main account. As an example of a sub-account, an accounts payable role may available to users who need access to billing information, but are not permitted to post shift requests. In contrast, a shift scheduler role may be allocated to an individual responsible for booking shifts, but not able to set price limits or view billing information. A shift supervisor may be responsible for direct oversight of a nurse and provided access to the evaluation process. A registered, non-contracted role may be defined for recruiters and/or other hospital staff. One embodiment of the functions and permissions associated with roles that may be associated with a health care facility are as set out in TABLE 1.

TABLE 1
HIRING ENTITY ROLES AND
PERMISSIONS

| | Registered, | Shift | Shift | Accounts | |
|---|---|---|---|---|---|
| | non-contracted | Supervisor | Scheduler | Payable | Manager |
| Edit Account Contact Info | X | X | | | X |
| Edit Accounts Payable Info | | | | X | X |
| Create & Manage Accounts | X | | | | X |
| My Billing | X | | | X | X |
| View Invoices | | | | X | X |
| Dispute Invoice | | | | X | X |
| Bill Pay Info | X | | | X | X |
| Shift Manager | X | | X | | X |
| Post Shift Form | X | | X | | X |
| Edit Shift Rates | | | P | | X |
| Cancel Shift Form | X | X | X | | X |
| Print Schedule (shifts) | X | | X | | X |
| Set Shift Preferences | X | | P | | X |
| Authorize Timecards | | X | X | X | X |
| My Professionals | X | X | X | | X |
| Rate Professional | | X | X | | X |
| Block | | X | X | | X |
| Add To Favorites | | X | X | | X |
| Search Pros | X | | X | | X |
| View Pro Bio | X | X | X | | X |
| View Pro Contact Info | | X | X | | X |

P = By explicit permission of Manager Only, set in Accounts form.

In the context of a health care facility, a worker may have one or more of various licensures, including NP, RN, LPN, CAN and/or personal aides. Worker accounts may be identified as a new user, a W2 Professional, or a 1099 Professional. A new user is a registered user who has not yet completed the requirements for work and has not been approved as a new worker, and as such may not accept or request shifts. A W2 professional may have successfully completed any employment application and other requirements, and has been accepted for payment as a W2 professional. A 1099 professional is a registered professional who has successfully completed the requirements and has been accepted as a 1099 professional. Functions and permissions associated with the roles are as set out in TABLE 2.

TABLE 2
PROFESSIONAL ROLES
AND PERMISSIONS

| | New User | Full W2 | Full 1099 |
|---|---|---|---|
| Shift Calendar | X | X | X |
| Calendar Day View | X | X | X |
| View Booked Shifts | | X | X |
| My Forums | X | X | X |
| View Forums | X | X | X |
| Post Forums | X | X | X |
| My Messages | X | X | X |
| Send/Reply | X | X | X |
| My Application | X | X | X |
| Documents | X | X | X |
| References & Work Hist. | X | X | X |
| Test Center | X | X | X |
| Take Tests | X | X | X |
| View Test Results | X | X | X |
| My Jobs | X | X | X |
| Shift Search | X | X | X |
| Search Preferences | X | X | X |
| My Timesheets | | X | X |
| Incident Report | | X | |
| My Ratings | X | X | X |
| Ratings History | X | X | X |
| FAQ | X | X | X |
| Provider Feedback | | X | |

In one embodiment, administrator roles allow users to monitor and administer the systems that provide the functionality of the workforce marketplace. Examples of such roles include, but are not necessarily limited to an executive role, an accountant role, an HR Manager role, a salesperson role, and a help desk role. Exemplary functions and permissions that may be associated with the roles are indicated in TABLE 3 below.

TABLE 3
ADMINISTRATIVE ROLES AND
PERMISSIONS

| Role | Executive | Accountant | HR Manager | Salesperson | Help Desk |
|---|---|---|---|---|---|
| Login | X | X | X | X | X |
| Manager Home | X | X | X | X | X |
| Professional Register | X | X | X | | |
| Professional Profile | X | X | X | R | R |
| Price Settings | X | X | X | | |
| Employment | X | X | X | | |
| Work History | X | X | X | | X |
| Reset Password | X | X | X | | X |
| Deactivation Form | X | X | X | | |
| Client Register | X | X | X | X | |
| Client Profile | X | X | X | X | R |
| Nurse/shift History | X | X | X | | X |
| Tax Settings | X | X | | | |
| Deactivation Form | X | | | | |
| Reset Password | X | X | X | X | |
| Professional Possession | X | | X | | X |
| Client Possession | X | | | X | X |
| Incident Reports List | X | X | X | | |
| Incident Form | X | X | X | | |
| System Settings | X | X | | | |
| State Settings | X | X | | | |
| Managers Roster | X | | | | |
| Manager Settings | X | | | | |
| Forum Manager | X | X | X | X | X |
| Create Forum | X | X | X | X | X |
| Message Center | X | X | X | X | X |
| Compose Message | X | X | X | X | X |
| Alerts & Iss. Assign. | X | X | X | | X |
| Reports: Sales | X | X | X | X | |
| Sales Revenue | X | X | | X | |
| Revenue by State | X | X | | X | |
| Revenue by Licensure | X | X | | X | |
| High Earner List | X | X | X | X | X |
| Reports: Activity | X | X | X | X | X |
| Shifts booked on pd. | X | X | X | X | |
| Hiring Stats | X | X | X | | |
| Tops: shifts | X | X | X | X | X |
| Tops: repeat shifts | X | X | X | X | X |
| Ratings report | X | X | X | X | X |
| Client Activity | X | X | | X | |

R = Read Only

In one embodiment, hiring entities may view the information about workers and professionals that are registered to participate in the marketplace. A search form may be used to search, for example, based on professionalism and reliability ratings, geography, skills, licensure status, handle and so on. Entities may save search settings for future shift requests as “QuickAdd” settings. In embodiments an entity may use the search functions to initiate a shift with a certain worker, whereas in other instances searching for specific workers is not permitted. In such embodiment, the hiring entity posts the shift such that all qualifying workers may be considered to fill the shift.

In one embodiment, workers are identified to entities by “handle” or nickname only, until they are booked to a shift. In some cases, workers may be hired based on qualifications and/or ratings and identified only by handle. If an entity books a worker to a shift, the entity may be granted access certain information such as the worker's name and contact information. In some cases, entities may view non-identifying data of the worker's profile, including skills, experience, ratings, and ratings history. In one embodiment, the ratings history may be displayed as graphs of the worker's reliability rating and professionalism rating over time. In some embodiments, certain information (e.g., a worker's home contact information) might be disclosed or hidden according to whether the worker has been previously been employed by the hiring entity and/or whether the user has need for or the permissions to view that information.

In one embodiment, workers may view details of the hiring entities. In some embodiments, however, the extent of detail displayed may be limited. For example, a worker may only see hiring entity details if she has previously worked at least one shift for that entity and/or if her qualifications match the needs of the entity. Further, the worker may not see details if the entity has indicated that worker is blocked from seeing such data. In one embodiment, all entity data may be marked as optional for public view. Any data so marked would be displayed in the public, or “brief,” view. In one embodiment, the brief view includes the name of the facility, the address of the facility, the type of facility (e.g., hospital, nursing home), and the department for the specific shift, if applicable. Full profile data may include contact name and telephone number, the ward or floor of a specific shift, if applicable, and the telephone number or extension for the location for the shift. Additional notes also may be provided.

If a worker has been assigned to a shift, information about that shift (date, time, place, duration, etc.) is presented to the worker when she selects a shift by, for example, clicking on a portion of a calendar grid representing the worker's weekly or monthly schedule. Once the shift is selected, the worker may then click on the entity name for that shift and more about the entity. In some embodiments, certain information (e.g., an entity's contact information) may be disclosed or hidden according to whether the worker has previously worked for the facility or not and/or whether the worker otherwise might have need for that information.

Log-In

In one embodiment, to access personalized sections of the site, users first log in using an identifier (e.g., username, handle, etc.) and password. Other forms of authentication (e.g., biometric, device-based passcodes, and so on) may also be used. The application may authenticate users requesting access to the system against a user table maintained in the database.

In one embodiment, if a user should at any time be associated with more than one user class role (e.g., represents a hiring entity and is also a worker), the user may be prompted to select which role they wish to assume for their present session. In one embodiment, once the user is logged in, the user is transferred to an appropriate page for their role.

In some embodiments, the system includes a secure messaging module that facilitates messaging among users of the system. Users may send messages to communicate with each other and with system administrators. In one such embodiment, they are prompted for which administrator they would like to send messages to (e.g., Administration, Client Manager, Human Resources, Ratings, Website Manager). Workers and hiring entities generally may not message each other. Users receive notification email at their preferred personal account when new messages have been delivered to their mailbox.

In some cases, users may also send or receive messages from other users and/or entities. In certain implementations, users registered as workers may only reply to messages they receive from hiring entities or system administrators. Users may elect to receive an email, mobile telephone text message, telephone call, or other notification when new messages are available. The new message itself may also be sent by email/text message/etc., and/or a notification and/or a link to the new message.

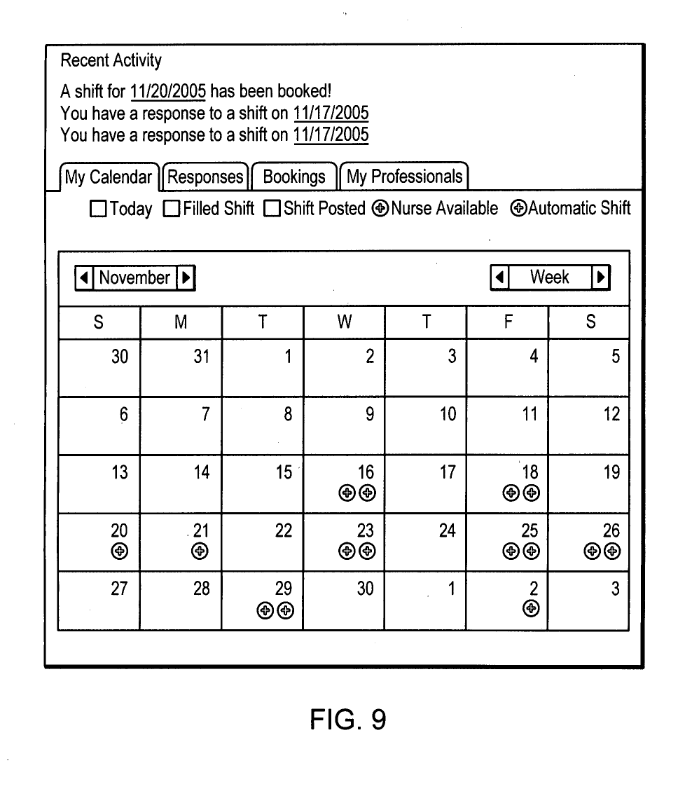

Referring to FIG. 9, once logged in as a user representing a hiring entity, a user may view an entity calendar to view and administer the shifts managed through the system. The calendar presents information about shift status and availability, according to specific needs of the user. The calendar may employ a matching routine to determine availability of workers, and use the user's shift schedule to present engagements. The calendar may provide a daily, weekly, monthly, quarterly and/or yearly display, and the user may manipulate the display to show the desired time frames and to scroll forward and back to chronologically adjacent time periods. The user may also use the calendar to begin posting a new shift, to manage shifts with responses, view posted shifts, and to view-at-a-glance the availability of workers.

In one embodiment, the calendar may indicate that workers are available on certain days by displaying icons on boxes for those days. In some embodiments, worker availability may be constrained by skill and date, and not shift price. In this way, entities may be informed that workers are available, even if it is at a higher price. In some implementations, a user can further filter the display based on price to see if workers are available at particular price points. The specific skills, ratings, prices and other requirements for the workers to be considered for shifts are displayed and may be indicated by using the QuickAdd function.

In one embodiment, as shown in the figure, if matching results are found, for example, a grey icon may be displayed, and if matching professionals with “autobook” are available, a red icon may be displayed.

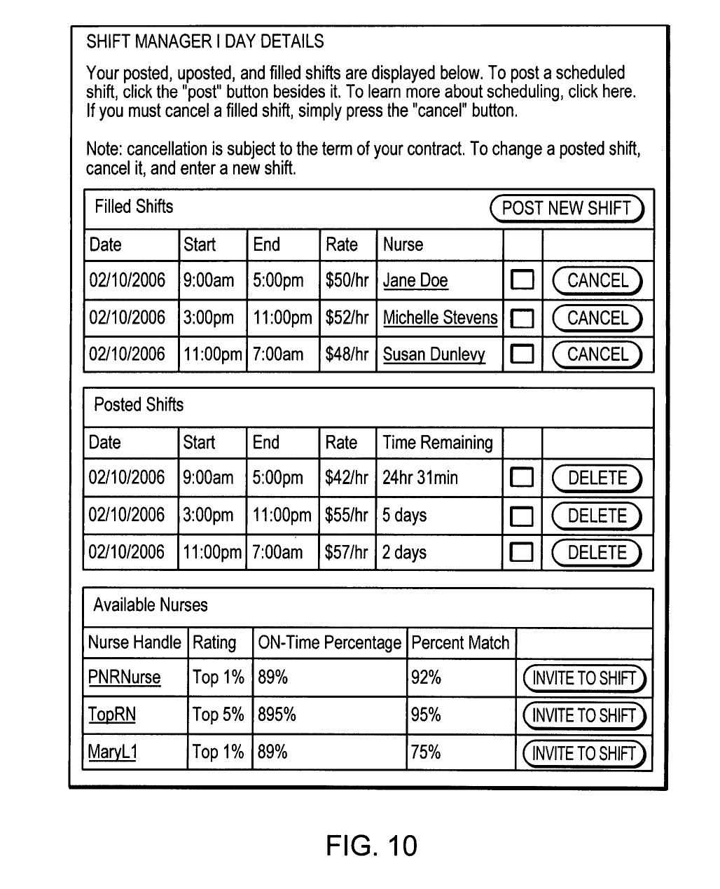

In one embodiment, and referring now to FIG. 10, clicking on a day in the calendar provides a detailed view of the shifts for that day. For an entity, this detail may include such information as filled shifts, posted shifts, shift responses, and the availability of workers to fill shifts. Likewise, a similar view is available for workers to view the shifts for which he is scheduled, as well as additional available shifts from one or more hiring entities. Color coding may be used to distinguish between shifts already scheduled and those that are newly available.

In one embodiment, the calendar is implemented as a JSP tag that represents a sophisticated calendar control. In addition to providing both a month view and a week view, it also allows the content of each cell (such as a day in the month) to be adapted to some data, such as the activities, for that day. In one embodiment, the calendar includes two tabs, one for the month view and the other for the week view, each of which may be controlled by month and week handles at the top of the main calendar. The content for the month and week views may be specifiable. For example, an application can specify the month handle to display the name of the month. Both the month and week handles may have two selectors (arrows) allowing the user to scroll to the previous and next month or week. The calendar may be specifiable as to which view and which month or week to load initially. By default, the month view of the current month is loaded. The week view allows for more detailed viewing of the data associated with a week.

In some embodiments, messages may be included on the shift view screen. For example, the screen may include notices regarding soon-to-expire certifications or licenses, upcoming training opportunities, the user's recent activity in the marketplace, updated ratings, and/or links to evaluations.

Managing Availability

In one embodiment, workers may search for shifts using a preference setting or by direct query. Entering shift preferences allows the system to automatically “shop” for available shifts on behalf of the worker. In addition, the worker may initiate a direct query, thereby allowing the worker to manually search for shifts meeting certain criteria.

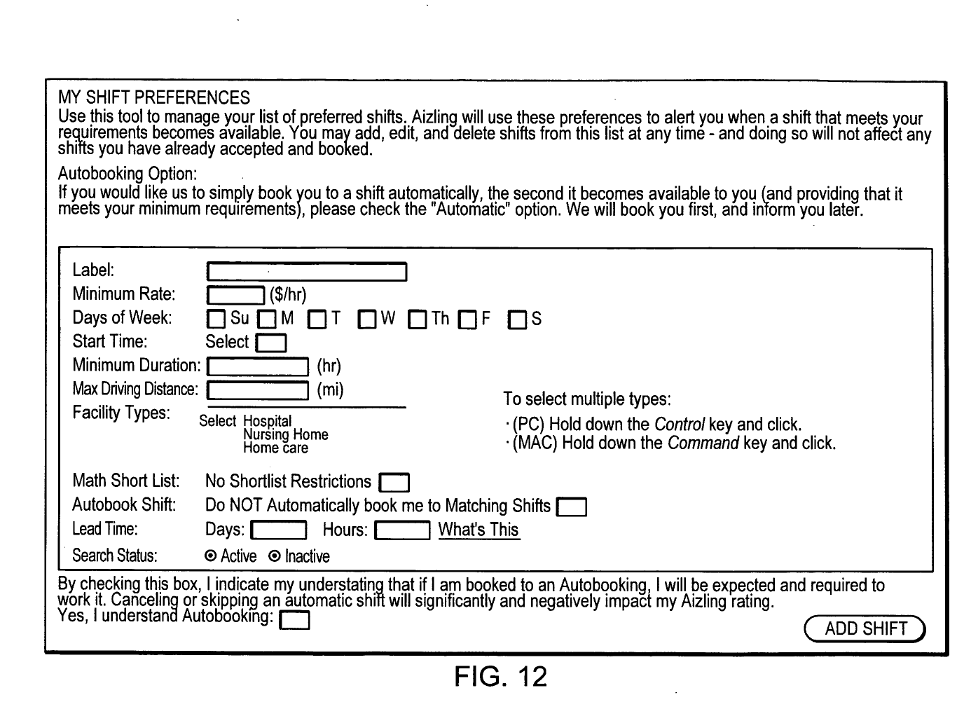

Referring to FIG. 12, a worker may complete a form with shift preferences such that the system will communicate notifications when shifts matching her preferences are identified. Notifications may take many forms, including email, text messaging, telephone calls, RSS feeds, etc. Information regarding a shift preference may include a label to uniquely identify the preference, a minimum pay rate, a start and end date range for the preference, specific days of the week to which the preference should be applied, the time that a time shift should start, a minimum and/or maximum duration of the shift, the maximum distance that the worker is willing to travel, a preferred facility type, an indication that the preference should only be matched with the worker's “short list” of providers, an “autobook” option to indicate matching shifts are to be automatically booked (e.g., if a matching shift is found and the worker is the highest rated), a minimum lead time required by the worker before the start of a shift for automatic booking (e.g., the worker may be notified but not booked if a matching shift is found with insufficient lead time), minimum notice time required for new shift in hours (also particularly useful for automatic booking); and an indication of whether the preference is active or inactive. Once the information is provided, the shift preference can be saved, and if active, executed. An inactive preference may be executed manually, to find any matches at the time of a manual query.

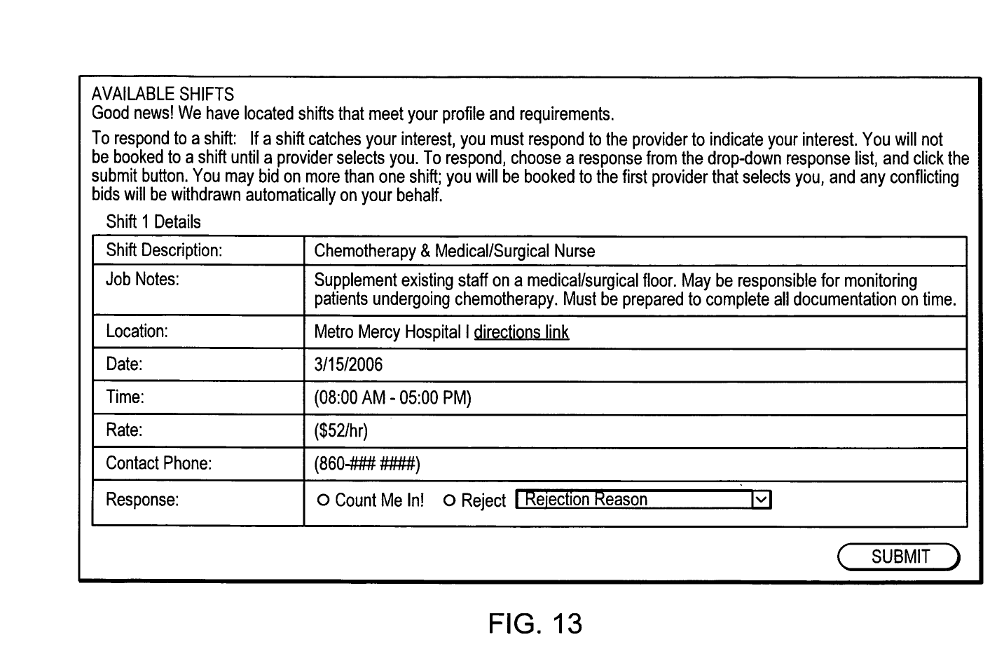

Referring to FIG. 13, following a manually executed query or in response to an automated search and match, search results may be displayed to the worker. The display of the search may include, for example, a short description of the position, a description of the skill needed, the name and location of the facility, the date of the shift, the start time, the rate, a response button (e.g., bid, reject), and a list of reasons why the shift might have been rejected (e.g., I am selecting another shift, shift not long enough, too far, pay too low, bad facility reputation, cannot work this day). Although one example shift is shown in the figure, it should be understood that there may be a number of shifts from which the worker may select.

In one embodiment, the worker may not respond to a shift if that shift conflicts with an existing shift. The worker may request a list of responses not associated with confirmed shifts for the day. In one embodiment, a response conflicts with a first shift if the end time is less than an hour before the first shift's start time, unless they are both at same facility. Likewise, any shift that has a start time more than one hour after the first shift would be conflicting, unless it was the same facility. If the shift is at the same facility, than the hour break may not be needed.

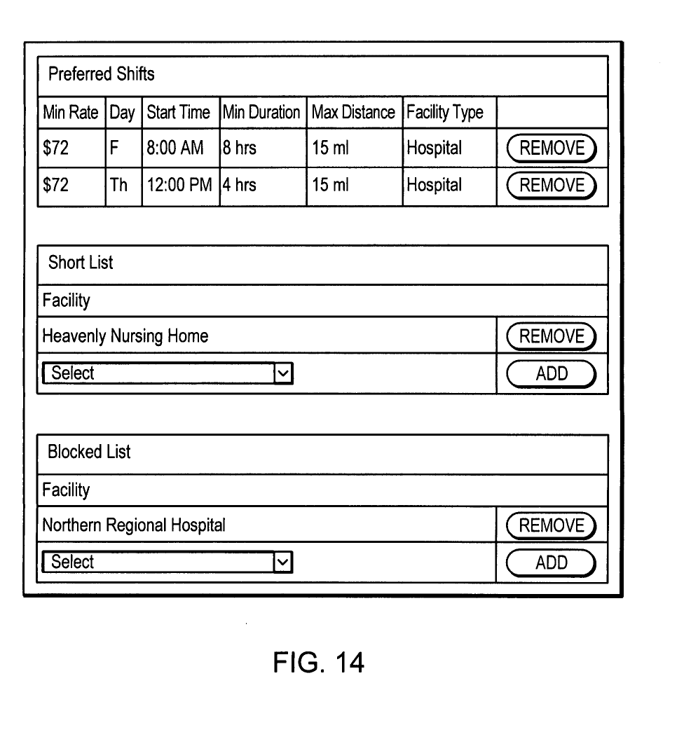

Referring to FIG. 14, a preferred shift list indicates active searches that are currently entered for the workers that system uses to find matching shifts. Parameters such as a minimum hourly (or in some cases daily) rate, day(s) of the week, shift start time, duration, distance from home (or other location) and type of facility or work may be included in the search, and the current values are indicated. If a worker is no longer interested in a particular shift, she can remove it from her list. The ability to enter multiple shift preferences, each with different parameters allows the worker to alter certain features of the search independently. For example, a worker may be willing to travel a greater distance or work off-hours shifts if the hiring entity is willing to pay a higher hourly rate.

Still referring to FIG. 14, workers may indicate certain entities as being on a “short list” of preferred entities for which the worker will work. In some embodiments, the worker may configure searches such that they are limited to hiring entities on her short list. In one embodiment, to add a facility to the short list, the worker must have worked a predetermined number of shifts (e.g., at least one shift) at that facility, achieved a minimum rating, received a favorable evaluation, or some combination. In one embodiment, a worker is presented with a drop-down list of available facilities (either all facilities, those that are within a certain geographic area, those that provide certain services, etc.) and adds the facility to her short list.

Still referring to FIG. 14, workers also may add hiring entities to a block list to indicate they are not interested in working at these facilities. In some embodiments, entities on the block list are excluded from future results lists for that worker, and the worker does not appear on that entity's autobook option. In one embodiment, to add an entity to a block list, the worker must have worked at least one shift at that entity. Similar to the short list, the worker is presented with a drop-down list of entities that can be added to her block list.

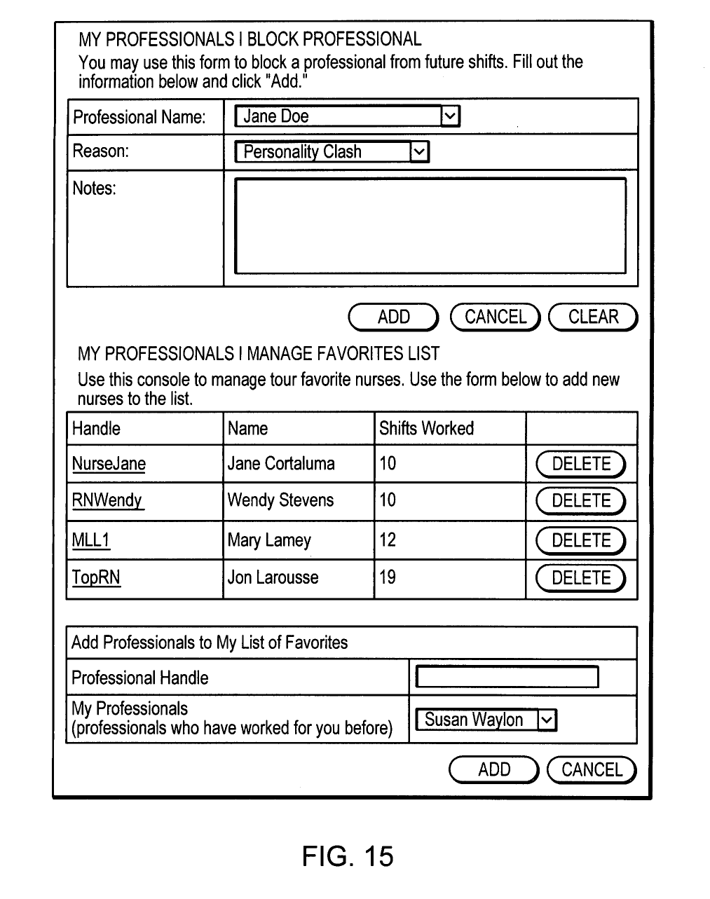

Referring to FIG. 15, in an analogous manner, an entity may maintain a short list of preferred workers and/or a block list of undesired workers. In some embodiments, QuickAdds and searches may be constrained to those workers on the short list, and not include workers on the block list. In one embodiment, to be included on either a short list or a block list, a worker must have worked a predetermined number of shifts (e.g., at least one shift) for the entity, achieved a minimum rating, and/or received a positive evaluation from the entity. In one embodiment, an entity may add a worker to a short list using the worker's handle, even if the worker has not worked for the entity in the past. In one embodiment, an entity may display and edit the workers on its “short list” and “block list.” To add a worker, the entity may complete a form with a drop-down listing of workers having worked for the entity, an indicator of the reason (e.g., personality clash, poor service, poor reliability, or another reason), and any additional comments. In one embodiment, when a worker is added to a block list, the worker may no longer be notified of a shift posted by this entity, may not view the entity's shifts in search results, and may not be automatically booked to the entity.

Posting Shifts

To seek out and hire workers, hiring entities post shifts and wait for responses. To do so, a user representing the entity enters preferences for skills, rate, ratings, location and experience.

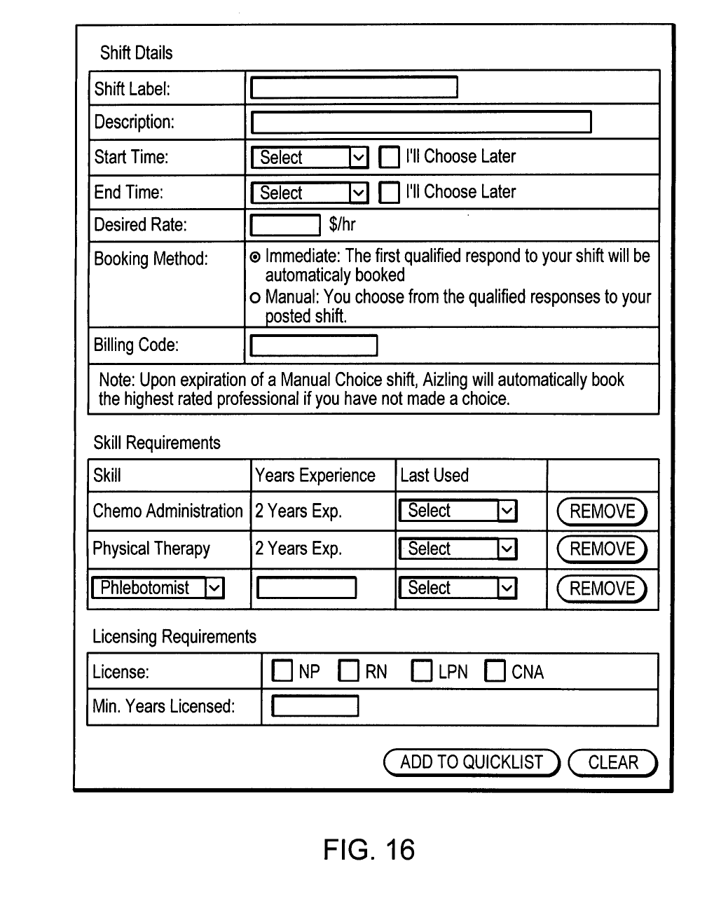

Referring to FIG. 16, if a user believes a shift is going to recur (e.g., the user knows that a particular date/time will repeatedly need to be filled), or if the user wishes to constrain the account to a few set rate/skill/experience profiles, the user can create and configure a “QuickAdd” profile reprenting that shift. To create a QuickAdd, the user completes a form having variable fields preset to certain values, persisted under a label as part of the web form, for example, such that the values describe details of the entity's preferences, and stores them for later use. For example, the user can indicate a short name for the shift (e.g., ER Triage AM), a description, and start and end times. In general, users can update the values, unless the user's permissions restrict them from doing so, as is the case when a main account restricts permissions to QuickAdds for subordinate accounts. If, for example, the user's actions are not constrained, a QuickAdd pre-populates the post shift form and the user may change the values if desired. If, however, the user's account is constrained, he may change only certain entries such as date and time entries, rate, skills and experience.

In one embodiment, shifts may be posted as immediate or manual. By selecting the immediate option, the first qualified worker to respond to the shift request is booked. If there are many immediate responses, a selection process is used to select the worker meeting one or more predetermined criteria. Examples of some of the criteria that may be used to determine which worker is assigned include consolidated ratings, lowest hourly rate, closest to the work site, or some combination thereof. If there are no responses or there are no workers available to fill the shift, the shift can remain open for some period of time (e.g., 30 minutes, up to an hour prior to the shift start, etc.). A billing code may be associated with the shift to help automate the billing and/or payment process for the shift.

In one embodiment, hiring entities may begin posting shifts from a calendar utility such as a wizard applet that walks the user through the shift add process step-by-step, or the user may enter the information onto a single page. In some instances, validation rules are applied (e.g., end time>start time, rate is >$0, etc.). In one embodiment, incremental validation against a run-time list of fields may be performed. This supports “wizard”-like functionality, where the user may be prompted for one or only very few fields at once and fields are validated as entered, as opposed to only once a user has competed an entire form.

In one embodiment, the current settings can be saved for later use as a “QuickAdd.” To do so, the user checks the “Save as QuickAdd” box, and provides a unique label. The form values may also be saved as a “draft” for later use and/or editing.

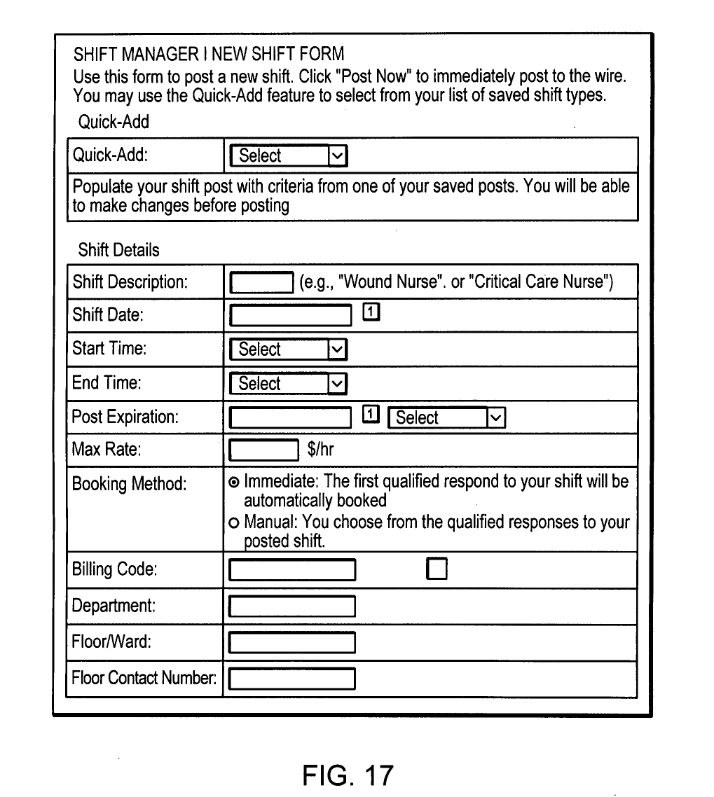

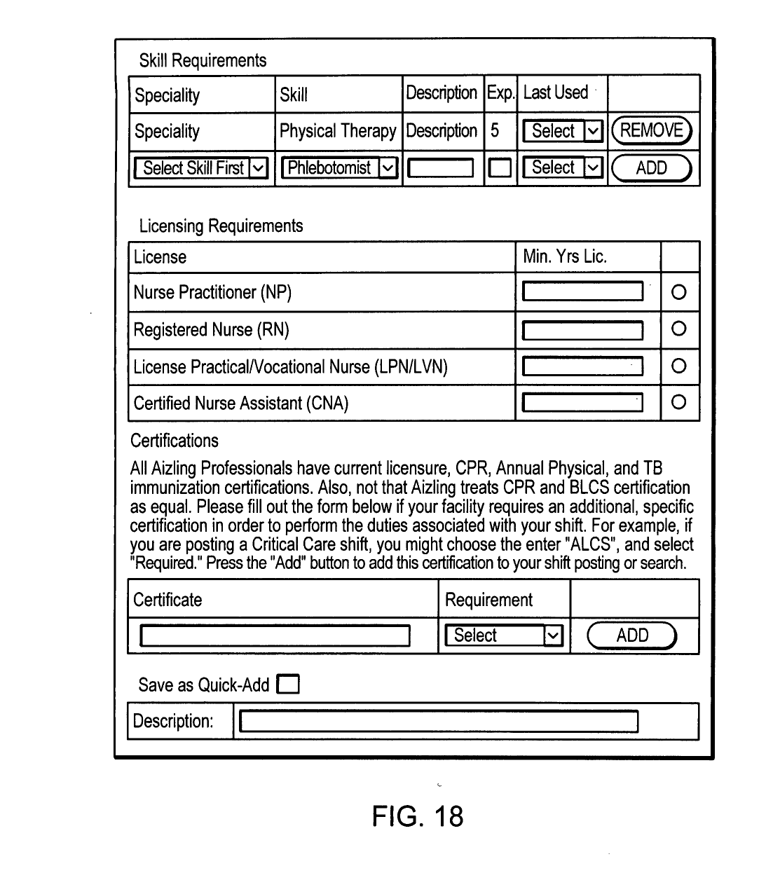

Referring to FIGS. 17 and 18, an exemplary new shift form includes information similar to the QuickAdd form, and allows use of a QuickAdd to complete some or all of the information for creating a new shift request and/or saving of the information as a QuickAdd. If a QuickAdd is selected, the QuickAdd information populates the form with some or all of the fields as previously entered when the QuickAdd was defined. In one embodiment, the user also may start from a saved draft of a shift. The user also may start by copying another of the user's shifts, essentially reusing parameters from one shift to create another. After filling the form with information from QuickAdd, another shift, or otherwise, the user may edit any of the fields in the form for which she has permission to do so.

Still referring to FIG. 17, the exemplary shift detail form includes a field for selecting a QuickAdd, the shift start date/time, the shift end date/time, the date/time that the listing should expire, the maximum rate that the hiring entity is willing to pay for the shift, the method by which the shift is booked (e.g., immediate for fast return, manual for user selection), a billing code associated with the shift, a department for which the shift will be worked, the floor or ward (location within the building) where the shift will be worked, the floor contact number, and additional notes that the hiring entity may wish to provide for the worker, if any.

Referring to FIG. 18, the hiring entity may also complete a skills form to indicate, select, and/or describe the skills required of the worker to perform the shift. In one embodiment, skill(s) are selected from a pre-existing list of skills, whereas in some cases the user may enter the skill(s) as free-form text entry. A minimum or suggested years of experience also may be included. In one embodiment, the time duration from which the skill was last used may be included (e.g., anytime, in the last 6 months, in the last year, in the last 2 years) such that a hiring entity can request a worker who has recently used that skill.

Licensing and certification requirements may be specified. For example, the hiring entity may complete a licensure form to specify the type of licenses or certifications a worker should have to be eligible to work at a particular location, for a particular entity, or to fill a particular shift. In some cases, a hiring entity may wish to select more than one type. In one embodiment, a selection of various types of licensures (e.g., NP, RN, LPN/LVN, CNA) is provided for selection. In another embodiment, a minimum number of years licensed may be specified. In other embodiments, professional certifications may be included, such as master electrician, professional engineer, MICROSOFT Certified Trainer, ORACLE Certified DBA, etc.

When a shift is posted, matches may be identified and stored in a memory structure. The matches may be sorted for example, by skill match, and composite score. Workers who qualify for this shift may be notified by system messaging and/or by the worker's selected notification method. Results may also be displayed on a worker's “home” screen when she logs in.

If matches are found, the entity selected the “Immediate Booking” option and any of the matches have configured the matching preference for the “Autobook Option,” a worker is selected and booked. In one embodiment, the worker with the highest composite score is selected. In another embodiment, the worker with an above average score who had the least work within a predetermined time period (e.g., the last 7 days) is assigned. In another embodiment, a worker with a score above a predetermined threshold (e.g., 75%) who has the most other shifts scheduled is selected.

If matches are found, and the hiring entity selected the “Immediate Booking” option but none of the qualified matches configured their matching preference for the “Autobook” option, the fulfillment of the shift may be delayed. Matching workers may be notified that an immediate shift is available, and they can log in and accept the shift.

For example, workers registered with the system may receive a message similar to the message below:

Subject: URGENT: IMMEDIATE NEED
URGENT: You qualify for an Immediate Booking Shift! The first professional to respond to this
shift will win it and be booked. To respond, you may click <here>, proceed through your
calendar, or through your Shift Manager.
This shift is available for 30 minutes only. It will be closed at: ##:## AM/PM, <day-of-week>,
mm/dd/yyyy
What is an Immediate Booking Shift?
A client posted a new shift, and asked us to find them the first available professional who meets
their skill and experience requirements. Unfortunately, no professionals configured an Autobook
Shift Preference for the time slot the client requested, so we couldn't book the shift right away.
Instead, we are notifying you and other professionals who qualify for this shift, and will wait 30
minutes for somebody to respond. The first to respond wins the shift!
What if we *had* found an Autobook Match?
We would have booked that professional immediately. If we found more than one, we would
have chosen the professional with the best composite reliability and professionalism score.
Thank You,
The Scheduler

The posted shift will be valid for a predetermined period of time, in this example, 30 minutes. The first worker meeting the requirements stipulated by the hiring entity and (in some cases, who accepts the shift) to accept the shift is booked.

If no worker was found to book this shift, the system may notify the hiring entity using one or more notification channels (e.g., email, text messaging, telephone, etc.). In one example, the message below is sent to the hiring managers:

Subject: Your Immediate Shift Could Not Be Booked!
Hello,
Unfortunately, we were unable to book shift
# ###### (<day-of-week>, mm/dd/yyyy at ##:##
AM/PM).
To increase the likelihood of booking a Professional, you could increase
the pay rate, or post the shift with more lead time (remember-you can
cancel anytime up to your contracted lead time, penalty-free).
The description of your shift:
<short-description>
<skill-list>
To log on and post a new shift, click <here>.
Or, if we can't help you, we at least make it easy for you to try our
competitors: to download a handy scheduling form that you can fax
to old-fashioned agencies, log in and use your Print Shift
tool. You may also click <here>.
Sincerely,
The Scheduler

In one embodiment, if one or more workers were found who match the shift and the Autobook feature was selected but there was insufficient lead time, the system may send a message to these workers in order to inform them that they are missing a shift for which they would otherwise have been scheduled. An example of such a message is as follows:

Subject: URGENT - Insufficient Notice for Autobook Shift
A shift has been posted that matches one of your Autobook preferences. However, the client did
not post the shift within the minimum notice time that you specified. Therefore, we have not
Autobooked you to this shift.
Shift Start: ##:## AM/PM <day-of-week> <mm/dd/yyyy>
Duration: ## Hours
Rate: $##.##
If you would still like to accept this shift, you must respond ASAP! You may click <here>, go
through your calendar, or use your Shift Manager.
Note: Other qualifying Professionals have also been notified for this shift. The first to respond
will win the shift.
This shift is available for 30 minutes only. It will be closed at: ##:## AM/PM, <day-of-week>,
mm/dd/yyyy
Thank You,
The Scheduler

In one embodiment, the hiring entity may specify an expiration date and time, but may view worker's responses to the shift and make the selection manually, thus providing the entity with an opportunity to decide which worker to hire based on qualities other than ratings. If no choice is made, the highest ranking worker to respond will be booked automatically upon expiration.

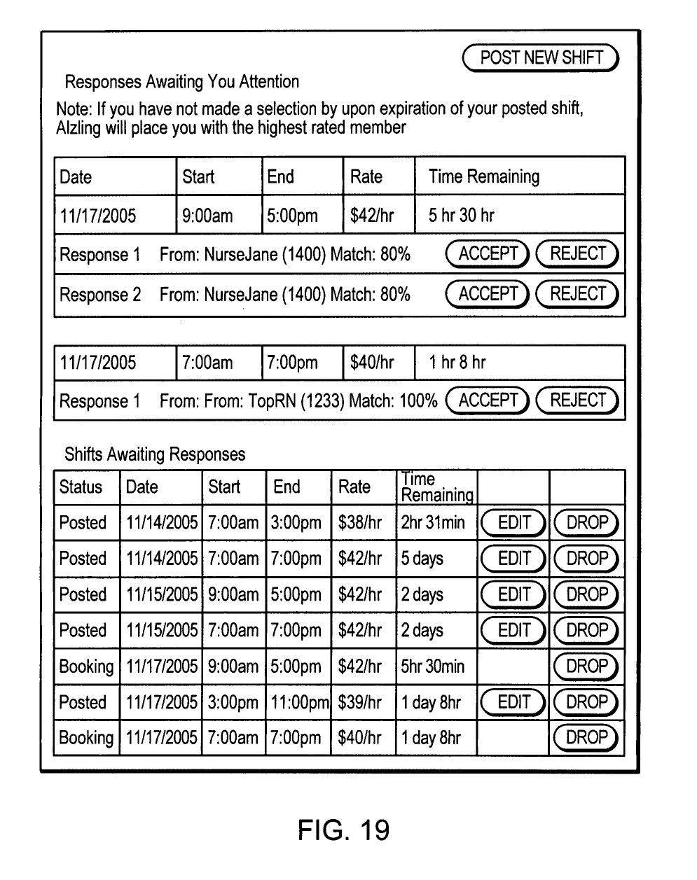

Referring to FIG. 19, a hiring entity may view the status of the shifts they have entered. In one example, the shifts are grouped based on status, e.g., shifts requiring the hiring entity to perform a task such as accept or reject a worker who posted for a shift, and shifts still awaiting responses from workers. The user may, for example, select a day from a calendar to see the shifts for that day. The user may also select a date range (e.g., week, month, or user-defined range) to view shifts. Information for each shift may be presented, such as the shift date, the number assigned by the system to the shift, the shift start time and the shift end time, the hourly rate, and the time remaining until expiration.

In one such embodiment, the hiring entity is presented with a list of workers that responded for each shift, and the hiring entity may then accept or reject each response. In one embodiment, the form includes shift details (e.g., date/time, rate, and time remaining until shift starts), and for each worker, a response index number, a handle or other identifier of the responding worker, a match percentage (e.g., the number of items matching and the total number specified), and the worker's rating (e.g., reliability rating, professionalism rating, and/or composite rating). Controls such as buttons or check boxes may also be included to allow the hiring entity to accept or reject a worker. If the hiring entity rejects a worker's response, the response is removed from the results list. In one embodiment, the worker is not notified of this activity, whereas in some instances the worker receives a message that he did not win the shift when the shift expires or is booked.

Shifts may be booked and confirmed in various ways. For example, the hiring entity may manually select a worker who responded to the post, and/or the system may automatically select one of the workers who responded based on certain criteria, such as rating(s), rates, etc. When a shift is booked, the worker and the hiring entity are notified.

The following is an example of a message to the worker upon being booked for a shift:

| Subject: Congratulations! You're Booked: <confirmation #> | |
|---|---|
| Dear <handle>: | |
| Congratulations! Your bid for the shift described below was accepted, | |
| and your shift is confirmed. | |
| Shift #: | ###### |
| Date: | mm/dd/yyyy |
| Facility: | <facility name> |
| Start Time: | ##:## AM/PM |
| End Time: | ##:## AM/PM |
| Description: | <information about the shift> |

Where to go once you're there:
<instructions provided by the facility>
Facility Contact Number: xxx-xxx-xxxx
For directions to this facility, please click here: <link to directions>
IF YOU THINK YOU'RE GOING TO BE LATE:
Please call the facility directly, and let them know.
If you have any other questions, please call us between 8:00 am
and 5:00 pm EST at: 800-800-8000.
Thank you - and it's great doing business with you!
Sincerely,
The Scheduler

The following is an exemplary message to the hiring manager upon having one of their shift requests fulfilled:

Subject: Congratulations! We booked your shift: <confirmation number>
Congratulations! Your shift was accepted and booked! Here's your
confirmation number: ######
If you have any problems or further questions, you can call us between
8:00am and 5:00pm EST at 800-800-8000. Please have your
confirmation number ready.
Your Professional:
Handle: <handle>
Full Name: <last name, first_name middle_name>
Reliability Rating: ##%
Professionalism Rating: ##
Shift Date:
Start Time:
End Time:
To send a message to this Professional, please click <here>.
It's a pleasure doing business with you!
Sincerely,
The Scheduler

Workers who responded to a shift, but were not selected may, in some cases, be notified as such. The message below is an example of a message indicating the worker was not selected for a shift.

```
Subject: Update: Shift Bid Results
Dear <handle>,
This message is to inform you that shift# xxxxxx was booked with a
different Professional.
Reasons why somebody else might have been booked:
  They had higher ratings
  They were on that facility's Short List
Sincerely,
The Scheduler
```

In some instances, a shift may not be able to be fulfilled. If a shift could not be booked, the hiring entity may be notified. An exemplary message to the hiring entity is as follows:

Subject: Shift Could Not Be Booked!
Hello,
Unfortunately, we were unable to book shift # ###### (<day-of-week>,
mm/dd/yyyy at ##:## AM/PM).
To increase the likelihood of booking a Professional, you could increase
the pay rate, or post the shift with more lead time (remember - you can
cancel anytime up to your contracted lead time, penalty-free).
The description of your shift:
<short-description>
<skill-list>
To log on and post a new shift, click <here>.
Or, if we can't help you, we at least make it easy for you to try our
competitors: to download a handy scheduling form that you can fax to
old-fashioned agencies, log in and use your Print Shift tool. You may
also click <here>.
Sincerely,
The Scheduler

In one embodiment, when a shift is booked or expired, notifications of available shifts are removed from the message centers of all workers who were notified.

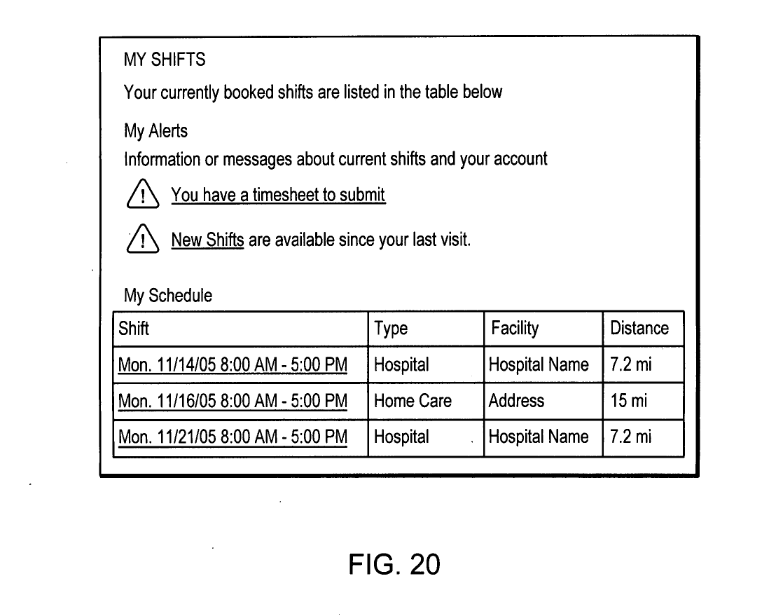

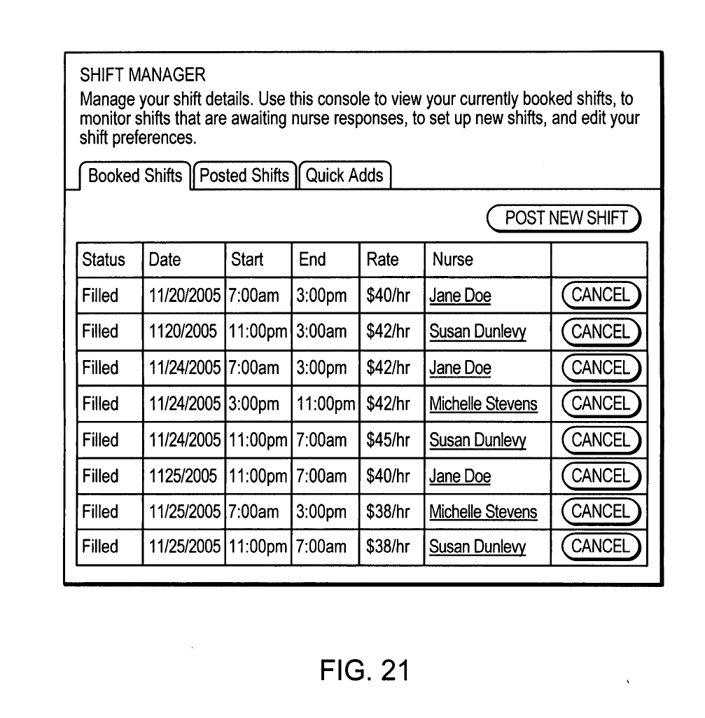

Referring to FIGS. 20 and 21, in one embodiment, hiring entities and/or workers can display and/or print their schedules to show booked shifts, shifts not booked, or both. As shown in FIG. 20, workers may view a list of the shifts for which they are currently booked, as well as information for each shift such as the facility type, name, the distance and in some cases suggested directions. In one embodiment, each of the presented shifts is a selectable link that, when selected, presents additional information about the shift, the facility, and the location. As shown in FIG. 20, the hiring entity may view a list of the shifts that have been filled, along with the worker booked on the shift a status, shift date, start time, end time, rate, and information about the worker (e.g., name and/or handle).

Cancel Shifts

A worker may cancel a shift for which she has already been booked to work and in some cases cancelled shifts may be reposted for other workers to fill. In some instances, however, canceling a shift may have a negative impact on the worker's rating. In one embodiment, the degree of penalty may be relative to the amount of notice given (e.g., canceling a week in advance may have no impact, whereas canceling the day of the shift may have a significant impact). Depending on the notice given, the hiring entity may be informed that either the worker has been replaced (if the shift was automatically refilled), or the shift has been cancelled. In cases of very short notice, system administrators may also be notified so that they may notify the hiring entity and/or take other action to attempt to fill the shift. In one embodiment, if there are more than a predetermined number of hours (e.g., 8 hours) before the shift start, the entity is notified with a low priority notice, whereas if the cancellation is less than the predetermined number, a high priority notice is sent.

The following messages are examples of notices to a worker and a hiring entity after a shift was cancelled.

Subject: Your Shift Cancellation
Dear <handle>,
We have cancelled the shift listed below. You are no longer booked to
work the shift. You do not need to take any further action at this point.
Reminder: Canceling shifts negatively impacts your reliability rating. To
learn more about your reliability rating, please visit here: <link>
Details on the cancelled shift:
Confirmation #:
Date:
Start Time:
Facility:
Thank you,
The Scheduler

Hiring Entity Low Priority

Subject: Shift Re-Posted
Dear <handle>,
Unfortunately, one of your booked shifts was cancelled by the
Professional. We have automatically reposted your shift, and have
extended the expiration date - no further action is required.
If you would like to cancel this re-post, please log into your account, click
to your Manage Shifts tool, and cancel the shift in the Posted Shifts tab.
Details on the cancelled shift:
Shift Date:
Start Time:
Rate:
New Expiration Date:
Thank you,
The Scheduler

Hiring Entity High Priority

Subject: Shift Re-posted
Dear <handle>,
Unfortunately, one of your booked shifts was cancelled by the
Professional. We have automatically reposted your shift for immediate
booking. No further action is required.
If you would prefer to cancel this re-post, please log into your account,
click to your Manage Shifts Tool, and cancel the shift in the Posted Shifts
tab. No penalties will be assessed.
Note that we take a severe view of shifts cancelled by Professionals with
little notice. This action has negatively impacted the Reliability Rating
of the booked Professional.
If you require further assistance, please do not hesitate to call us. We can
be reached between 8:00 am and 5:00 pm EST, Monday through Friday,
at 508-830-0016.
Shift Detail:
Confirmation Number:
Date:
Start Time:
Rate:
New Expiration Time:
Thank You,
The Scheduler

Administrator-HR Manager: Late Cancellation Notice

Subject: LATE CANCELLATION NOTICE
<professional handle> cancelled a shift with less than x hours
notice for <facility-handle>.
Date:
Start Time:
End Time:
Rate:
Facility:
Description:
Shift Number:
Confirmation Number:

A hiring entity may also cancel a booked shift. Depending on contract terms, a penalty fee (e.g., a percentage of the shift price) may be assessed and sent to the worker as compensation. Upon cancellation, the worker is informed of the cancellation. If cancellation is within 1 hour of start time, a high-priority notification may be sent to an administrator, so the administrator can take steps to contact the worker directly. In one embodiment, hiring entity cancellations of reposted shifts following a cancelled shift within 8 hours of the shift's start time do not incur penalties.

Timecards

In some embodiments, the workforce marketplace also facilitates tracking and payment for shifts worked. In one example, workers enter start and end times for each shift into a timesheet system. Workers may also need to maintain paper copies of timesheets in situations where the hiring entities require hardcopy timesheets. The hiring entities provide authorization for time worked on a shift-by-shift bases, for all shifts completed by a particular worker, or for the entire entity.

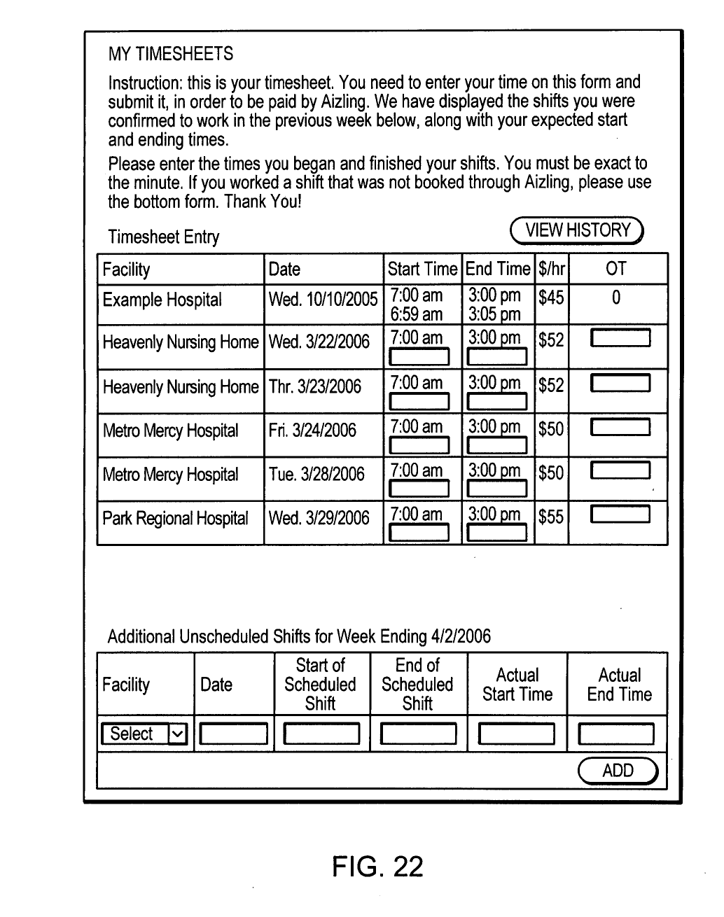

FIG. 22 illustrates one embodiment of a timesheet used by a worker to enter data for the shifts she has completed. In one embodiment, the timesheet form includes the details from the shift (e.g., date, scheduled start time, and scheduled end time). The worker may override some or all of the information in instances where the shift times were modified or if additional (or fewer) hours were worked than originally scheduled. In some embodiments, users can enter data for shifts that were not scheduled using the system.

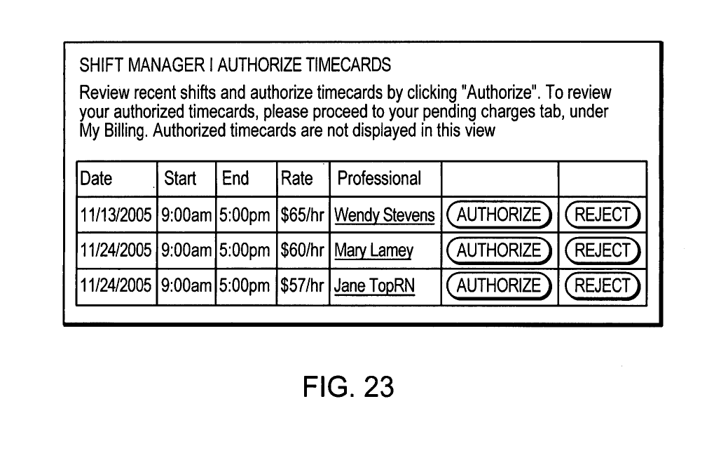

After the worker has entered and submitted her timesheet, it may be forwarded to the hiring entity for approval. Referring to FIG. 23, in one embodiment, timesheets may be authorized by a user representing the hiring entity by specifically authorizing one or more entries, or by the passing of an expiration date. If the expiration date passes with no response from the hiring entity, for example, the shift may be deemed accurate and settled. In one such embodiment, the entity may dispute a shift upon receipt of an invoice, in which case the worker may be required to provide an original timesheet to settle the dispute.

In one embodiment, the user responsible for approving timesheets is presented with a list of shifts for which workers have submitted timecards for that entity. The list may include a text field in which users can enter descriptive text for the entry and/or an explanation as to why a timesheet entry is being challenged, the time the worker actually began working, the time the worker actually left, the hourly rate charged, the worker's handle, and an action button to accept and to reject the entry. The user may review the shifts and either authorize or reject each entry, or all the entries simultaneously. If authorized, the timesheet information may be used to determine a reliability rating for the worker. If the timesheet is rejected, both the hiring entity and the worker may be notified of the challenge to the timesheet. In one embodiment the worker is automatically requested to submit her original timesheet if the online timesheet is rejected by the hiring entity.

Below is an example of a notification message that may be sent to the worker upon having a timesheet rejected.

```
Subject: Your Timecard was Rejected
Dear <x>:
We regret to inform you that there is a problem with your timecard entry
for the shift listed below. The facility has rejected your entry, and we
need you to send us more information.
Confirmation Number:
Date:
Facility:
Description:
Start and End Times you provided to us:
Start Time:
End Time:
In order to resolve this issue, you MUST SEND US YOUR ORIGINAL
TIMESLIP through US Mail. Our address may be found at the bottom
of this email. To expedite resolution, we strongly recommend that you
also fax a copy of your timecard to us. Our fax number is listed below.
If you have already mailed your original timecard to us, you don't need
to take any further action. We will contact you if we have any questions.
Per your acceptance of our Terms And Conditions, please recall the
following very important messages:
  Failure to mail the original, paper timecard by the date listed below
    could result in your account being suspended, and your booked shifts
    cancelled.
  Failure to mail the original paper timecard WILL negatively and
    significantly impact your reliability rating.
  Modification of the timecard in any way will result in immediate
  termination of your employment.
  You will not be paid for this shift until the problem is resolved.
Mailing Address:
  Ratings Resolutions
  <address>
  Baker, MA xxxxx
Our fax number:
  xxx-xxx-xxxx
On the cover letter of your fax, please include the following information:
  Your handle
  c/o Ratings Resolution
  Shift Confirmation number ######
If you have any questions, please do not hesitate to call! We want to help
you resolve this problem ASAP!
Sincerely,
The Ratings Team
```

A similar message may be sent to the hiring entity, an example if which is below.

```
Subject: Timecard Challenge for <handle>
Hello,
This message is to acknowledge our receipt of your challenge to the
timecard entry provided by <Pro First Name> <Pro Last Name>
for the shift detailed below:
Shift Confirmation Number:
Date:
Rate:
Start Time:
End Time:
Description:
You have challenged the following data, which was provided by the
Professional:
Start Time:
End Time:
The corrected entry that you provided to us:
Start Time:
End Time:
We have noted your challenge. You will not be charged for this entry until
the issue is resolved.
Further Action:
Please fax your copy of this professional's timecard to us. Our fax
number is given below. In addition, please include the following
notes on your cover letter:
  Your Facility Name
  Shift Confirmation Number
  Shift Date
Note: we are retrieving the original timecard furnished by this
Professional. If properly signed, this document will be considered the
final authority in resolving this issue. We MUST have your copy of this
document to address any further problems. Failure to provide this
document in a timely manner (post dated within 1 week of today) may
result in the summary reinstatement of this timecard.
Please do not hesitate to call us if you have any further questions!
Sincerely,
The Ratings Team.
```

In one embodiment, challenged timesheets are not authorized, and therefore not counted in reliability ratings. In such cases, the ratings do not include the challenged shifts until the discrepancy is addressed.

In one embodiment, when a hiring entity challenges a timesheet entry, the entity can correct the start and end times entered by the worker. An alert may be sent to the worker indicating that a change has been made, that the timesheet (or individual shift) is designated as challenged, and is being held pending adjudication, and not processed for ratings nor payment. To address the challenge, the worker may, for example, mail an original timesheet to system administrators. If, for example the original timesheet has been signed by an authorized representative of the hiring entity, the data on the timesheet is used to settle the dispute.

In one embodiment, when a timesheet is challenged for start and end times, a “reliability ticket” is created. An administrator may use an on-line tool to view and/or resolve reliability tickets. The administrator may select a ticket from a list and edit the ticket information. The administrator may upload documents to be referenced in the ticket. An administrator may record the static data on the challenged shift. For example, to resolve a reliability dispute, documents may be used such as the worker's timecard copy, the worker's original timecard, the hiring entity's timecard copy, the entity's original timecard, and the entity's digital authorization.

Evaluations

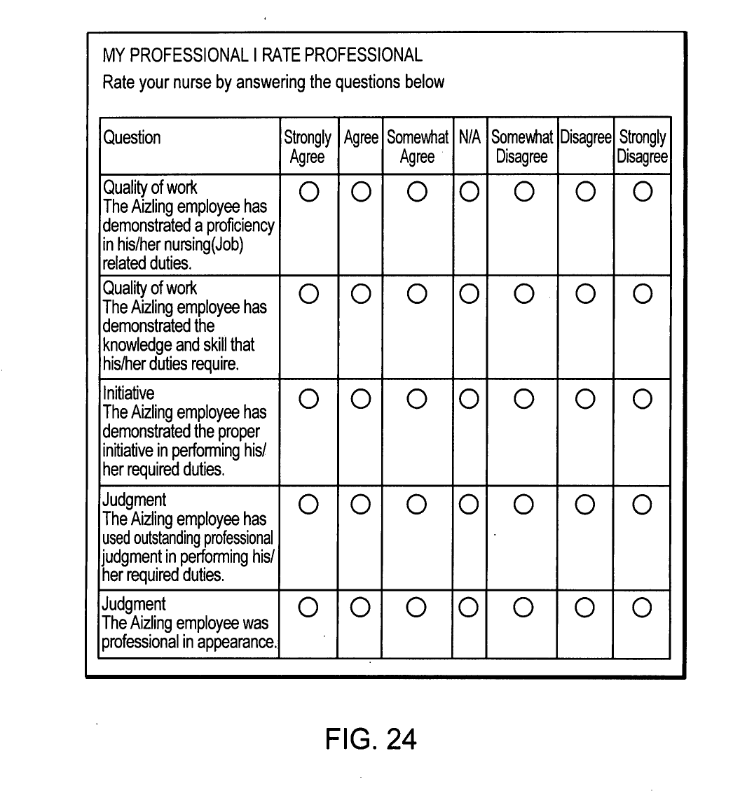

Hiring entities may evaluate workers' performance and/or reliability based on completed shifts using various methods. Referring to FIG. 24, for example, users representing the entities complete a questionnaire or survey regarding the worker's performance. The evaluation questionnaire may, for example, be initiated based on the users selection of an individual worker from a list of workers having recently completed shifts for the hiring entity. Such a selection may be made from a drop-down selection box that includes unevaluated workers. In some embodiments, workers are not evaluated for shifts cancelled by the provider. In one embodiment, hiring entities may submit evaluations for workers once for each shift.

Workers may be evaluated according to various scoring methods. In one embodiment, the workers are evaluated according to the following scale as applied to a series of questions related to the quality of the work done, the worker's initiative, their judgment, their overall professionalism, subject area knowledge and other job-related parameters.

Professionalism Ratings Options

| Option | Points |
|---|---|
| Strongly Agree | +4 |
| Agree | +3 |
| Somewhat Agree | +2 |
| Neutral/NA | 0 |
| Somewhat Disagree | −2 |
| Disagree | −3 |
| Strongly Disagree | −4 |

Examples of the questions that may be posed to the user evaluating the worker include the following:

Professionalism Survey Questions

The professional has demonstrated the knowledge and skill that
his/her duties require.
The professional has demonstrated a proficiency in his/her
nursing(Job) related duties.
The professional was professional in appearance.
The professional has demonstrated proper initiative in performing
his/her required duties.
The professional has used outstanding professional judgment in
performing his/her required duties.
The professional has completed all documentation required of his/her
duties.
The professional has demonstrated the requisite communication
skills that his/her duties require.
The professional has demonstrated a high degree of professionalism
in his/her interaction with patients.
The professional has demonstrated a high degree of professionalism
in his/her interaction with staff.

Over time, the questions may evolve to reflect more relevant questions, the addition of new types of work being performed, or to revise questions that do not elicit accurate responses. In one embodiment, the questions are editable by a user having system administrator rights via a configuration file and are maintained in XML format.

Similarly, workers may also submit feedback on and/or evaluations of hiring entities. Such information may take the form of notes attached to a submitted timesheet, or posted in a common area such as a blog, wiki or chat room to which other uses have access. In some embodiments, the feedback is limited to numerical ratings or short tags (e.g., excellent, good, average, or poor) so the workers are not able to enter disparaging remarks. In certain instances, hiring entities may appeal a poor rating or request that the system administrator investigate the rating, and if it is deemed improper, remove the rating.

Evaluation Appeal

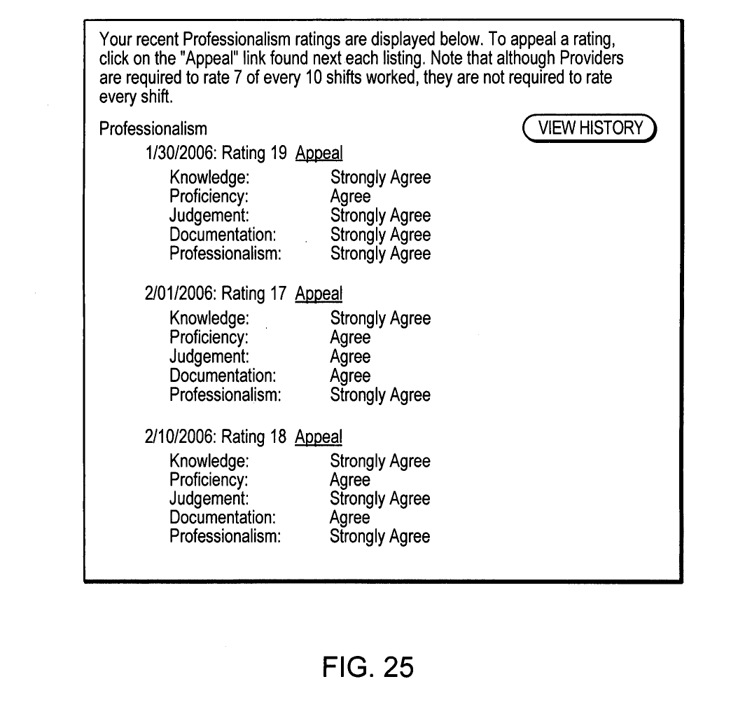

Referring to FIG. 25, in one embodiment, workers are permitted to view evaluations provided by the entities for which they worked. For example, a notice may be sent to the worker that an evaluation is available for review, and the worker may then log in to the system to view the evaluation. In some implementations, the worker may challenge (or “appeal”) the evaluation if she believes the evaluation is not accurate or unfair. In some cases, there is a limited amount of time (e.g., one week) during which the worker is able to appeal the evaluation.

In some cases, the appeal of an evaluation has no affect on the evaluation, whereas in other instances an appealed evaluation may be ignored or discounted to some degree. If an evaluation is successful, the new evaluation may override the original evaluation, be used in the calculation of ratings, or both.

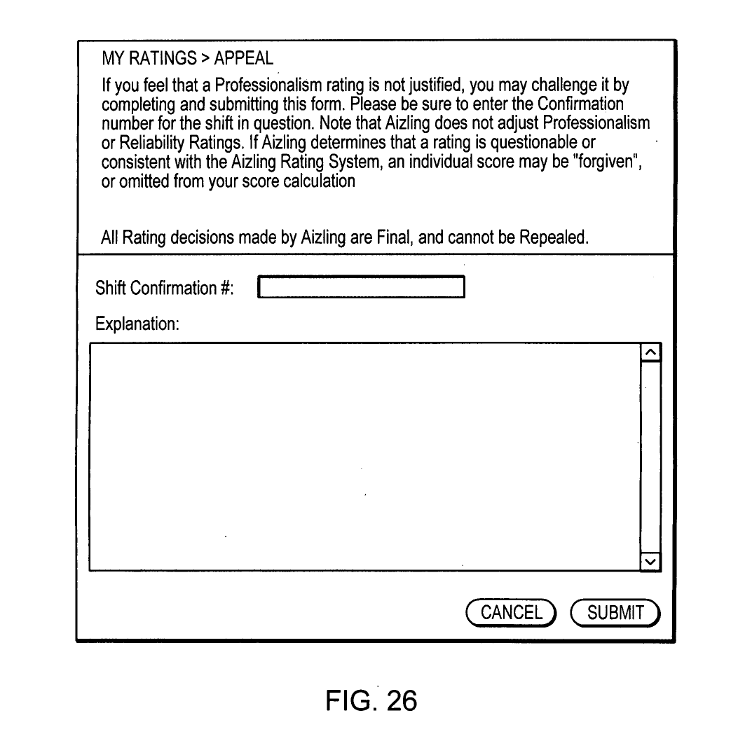

Referring to FIG. 26, a user may complete and submit a form to the system administrator to request an appeal and/or explain her reason for appealing an evaluation. The request may include the confirmation number for the shift, and an explanation of the worker's reason for filing the appeal. Submission of an appeal results in the opening of an appeal ticket, consideration of the appeal by an administrator, and an eventual resolution. The resolution may be based on submission of additional information, documentation, interviews with the worker and/or interviews with staff members from the hiring entity.

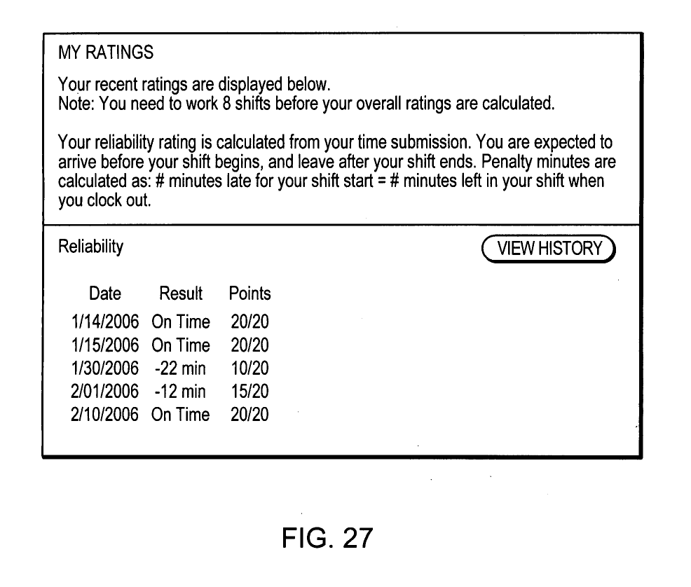

Referring to FIG. 27, in one embodiment, workers may also view a “My Ratings” page that summarizes timesheet information and reliability ratings. Such information may include the date/time of the shift, a shift identifier, the name of the hiring entity, an indication as to whether the worker was on time, an amount of time the worker was late and/or left early, and the point rating that results from the timesheet data.

Ratings

In some embodiments, workers' reliability and professionalism statistics may be generated and/or updated after some number of timesheets have been approved and evaluated. For example, a reliability rating may be based on a minimum number of timesheets (e.g., 4) to avoid a skew in the ratings based on one timesheet. In one embodiment, the reliability rating is calculated based on a worker's timeliness to work and her promptness in informing her hiring entity of any planned absences from work. The professionalism rating is calculated based on the feedback on the worker as determined in evaluations.

Example Reliability Rating

In one embodiment, reliability ratings are calculated for each worker based on credit points, penalty points, reliability bonus and reliability reduction, and calculated according to the formulas below:

$$RawEarned = \frac{{\sum }_{1}^{N} {PntsEarned}_{N}}{( {\sum }_{1}^{N} {PntsPossible}_{N} + {\sum }_{1}^{N} {PntsPenalties}_{N} )}$$

Reliability=(1+BonusMultiplier)*(1−ReductionMultiplier)*(RawEarned)

Credit points are earned for each shift worked, as represented by the Timesheet interface, with more points earned for more timeliness. One possible example of how to allocate credit points is described in the table below.

| Minutes Late + Minutes Left Early | Credit Points (PntsEarned) |
|---|---|
| 0-10 | 20 (PntsPossible) |
| 11-15 | 15 |
| 15-30 | 10 |
| 30-60 | 5 |
| >60 | 2 |

Penalty points may be assessed for shift cancellations, with more points assessed for shorter notices and/or increased cancellation frequency. One possible example of how to allocate penalty points is described in the table below.

| Cancellations | Penalty Points (PntsPenalties) |
|---|---|
| 1 to 2 Days | 5 |
| 12 Hours to 1 Day | 7 |
| 8 to 12 hours | 10 |
| 2 to 8 hours | 15 |
| <2 hours | 30 |
| Cancel after Shift Start | 50 |

Bonus points may be awarded for working consecutive (or almost consecutive) on-time shifts. One possible example of how to allocate bonus points is described in the table below.

| Past # of Shifts | # of Misses | Bonus Points Awarded |
|---|---|---|
| 10 | 0 | 2% |
| 30 | 1 | 5% |
| 50 | 2 | 10% |

The allocation and assignments of credit points, penalty points and bonus points may be configurable based on individual entities, as some hiring entities may value timeliness to a greater extent than other, some entities may not consider working consecutive shifts as meriting bonus points, etc. In one implementation, the allocation of points is consistent across all entities to allow for an accurate comparison among workers across the entire system.

Professionalism Rating

A worker's professionalism rating may be calculated based on evaluation results received from hiring entities. In some implementations, the answers submitted on the evaluation surveys may be converted to point value through a mapping from the answer number to a number (positive or negative) to be added to the point value. One example of a point mapping is indicated in the table below.

| Answer number | Points |
|---|---|
| 0 | +4 |
| 1 | +3 |
| 2 | +2 |
| 3 | 0 |
| 4 | −2 |
| 5 | −3 |
| 6 | −4 |

For example, using the mapping table above an answer-sheet containing answers numbers {0, 1, 0, 2, 5} will generate a point value of 10 (4+3+4+2−3). The point value may then be adjusted using one or more point adjusting techniques. For example, the adjustment may be based on a rater handicap that attempts to normalize the ratings among raters, so workers are not penalized for working for more stringent entities.

One method of determining a handicap for a rater (often with a predetermined number of assessments/ratings such as five) includes calculating the mean and standard deviation of all submitted assessments, and the mean of the particular rater's assessments. The handicap may then be calculated as the difference between the two means. For example, if the overall mean is ten, and a rater's mean is eight, then the handicap for that rater is two, and the point value for evaluations submitted by that rater may be adjusted upward by two.

In some embodiments, the point value may be further adjusted as follows. For certain parings of workers and raters, the point value is computed as an average of the point values over some period of time (e.g., the most recent two-week span). The period of time may be configured to start with when that pair is first encountered (e.g., when the rater first submitted an evaluation for that worker). The time periods may be fixed or sliding windows. The average point value is then used to calculate the rating value for a worker as:

$$Professionalism = \frac{{\sum }_{1}^{N} {PntsEarned}_{N}}{{\sum }_{1}^{N} {PntsPossible}_{N}}$$

where PntsEarned is the average point value and PntsPossible is the maximal possible points for the rating system.

For example, if there are five entries in the survey answer form with the points table shown above, the PntsPossible will be 5*4=20. If there are no entries within the time window, or if the current time has not passed the end of a time window for the particular worker/rater pairing, then there is no contribution from this pair. The adjusted point value data may still be kept, to be used to contribute to future calculations. The mapping of answer numbers to points may be configurable, such that a greater (or lower) emphasis is placed on different answers.

In some embodiments, a consolidated rating for a worker is calculated as a weighted combination of the reliability rating and professional rating. The weight attributed to each component of the consolidated rating is configurable such that different entities can weight the components according to their own formula. For example, in one embodiment:

$$ConsolidatedScore = \frac{2}{5} Professionalism + \frac{3}{5} Reliability$$

In one implementation, the points and bonus tables, and the consolidated rating weight are configurable.

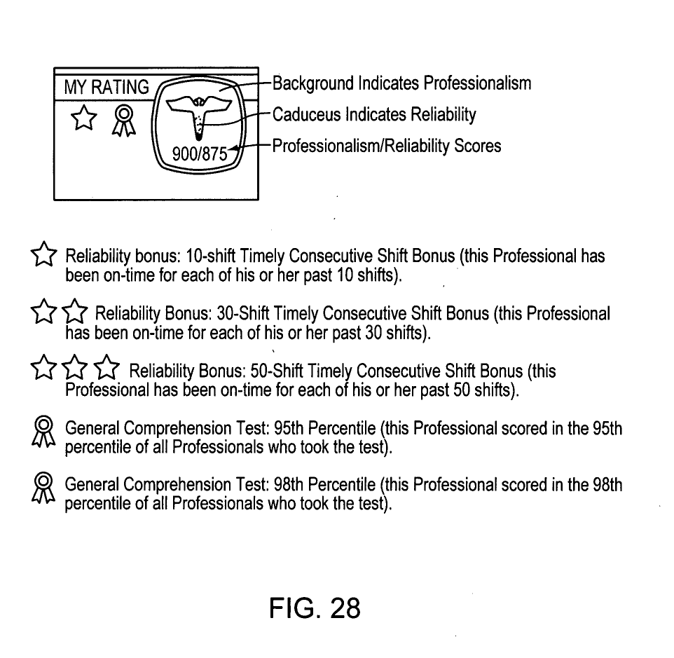

Referring to FIG. 28, in one embodiment, a rating for a worker is displayed as a medallion on the workers rating screen to illustrate her rating at a glance. For example, the background color of the medallion may indicate the professionalism score, which can also shown in numeric form. For example, orange might be used for ratings between 900-1099, blue for 800-899, green for 600-799, yellow for 400-599, and white for 0-399. Other colors may be used for other ranges. The use of the color on the background provides a graphical representation of the rating. In the example of FIG. 28, the professionalism score is 900. In addition to the current rating, icons and text may be used to indicate bonuses received such as a reliability bonus for 10, 30, or 50 on-time shifts. Likewise, an indication of a high score on the registration test may also be indicated with a colored ribbon. As shown in the figure, a numeric display of the reliability score is also shown. In this example, the reliability score is 875.

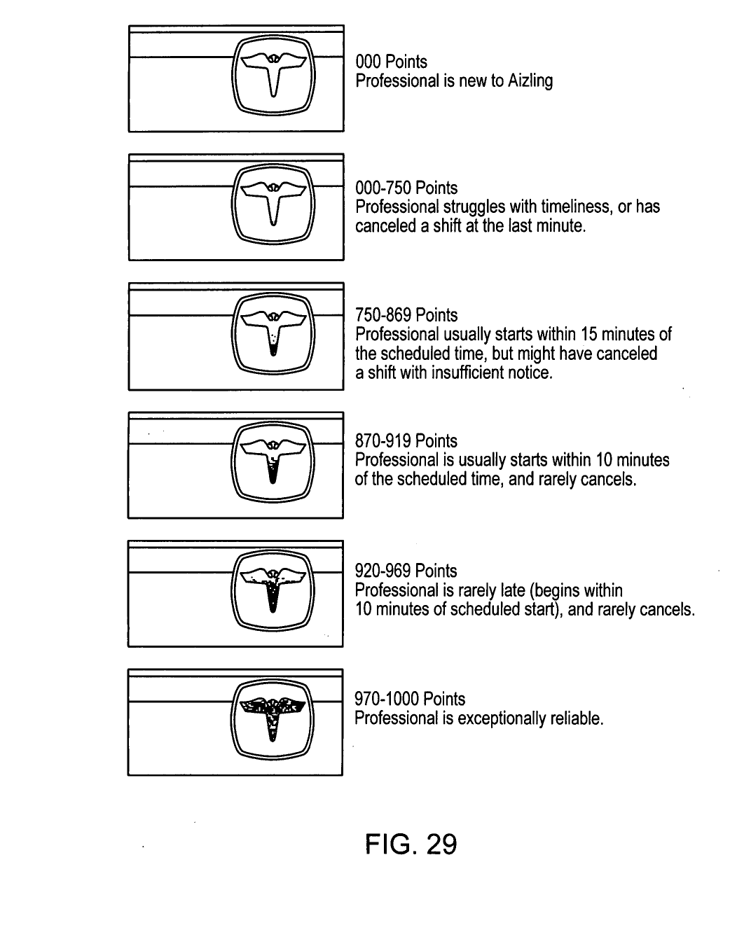

As shown in FIG. 29, the color of the caduceus of FIG. 28 indicates reliability. With a higher reliability rating, the caduceus is filled higher with color. The use of the visual display of the rating allows an observer, such as a provider, to evaluate quickly the professionalism and reliability of a worker.

Matching Process

Determining which workers are potential matches for posted shifts may include filtering workers based on price, geography and/or skill ratings. Each are described in greater detail below.

The price that can be offered to a worker may be a function of numerous parameters, including the amount the hiring entity is willing to pay. This allows the system administrator to handle taxes and insurance payments due to various governmental agencies, as well as make a profit. In one embodiment, the values that are considered when calculating the wage offered to the workers are listed in the table below, and the calculation is provided in the following formula.

Net-To-Professional Formula Key

| Code | Description | Source |
|---|---|---|
| BillRate | Bill Rate specified by Provider | Provider Entry |
| Net | Net Pay to Professional (excluding withholding) | Professional Preference |
| Wc | Worker's Compensation | Client Setting |
| Ue | Unemployment Insurance | State Setting |
| Margin | Profit Margin | Client Setting |
| GI | General Liability | Global Setting |

Bill Rate = (Net)(Wc)(Ue) + Margin(Net) + Net + GI
BillRate - G1 = Net(WcUe + Margin + 1)
$\frac{BillRate - GI}{( Wc ) ( Ue ) + Margin + 1} = Net$

Once the net payment for a shift is determined, the list of workers having a minimum rate greater than the net payment can be used as an initial match population to fill the shift. In some instances, the minimum rate may be adjusted for workers who have (or will have) worked 40 hours or more (or some other overtime threshold) since the last bill period. In such cases, the rate may be adjusted by an overtime factor, such as 1.5. Any worker having a minimum rate (or overtime rate) above the net payment is not considered for the shift.

In some instances, a worker may have entered a minimum price that is too high given the available shifts, an entity may have posted shifts with too low of a payment, or both. In each case, no matches will be automatically identified if price is considered as a key match parameter. In such cases, a message may be sent to the worker indicating that there are shifts available at lower prices, and she may want to consider adjusting her minimum price. Likewise, the hiring entity may be forced to increase the payment offered for a shift if it is too low as compared to the workers' minimum rates and shifts being offered by other entities.

In some cases, the system can calculate average rates for shifts based on parameters such as geography, skill level and ratings. For example, a hospital may need to fill a shift for an ER nurse at an inner-city hospital on a Saturday night. Because the system has historical records of previously worked shifts with similar parameters, a suggested rate can be provided to the hiring entity. The suggested rate may also consider the number of workers with those skills within a maximum distance to properly set the expectations of the hiring entity as to the probability of filling a particular shift. In certain embodiments, the system may indicate that, should the entity raise their offer price by a certain amount, additional workers will meet their criteria and be considered for an otherwise unfilled shift.

Workers that do not have availability for the listed start times and dates and any that are on a block list maintained by the hiring entity are further eliminated from consideration as possible matches. Further, location-based preferences are considered by determining the distance between each worker and the hiring entity. In one embodiment, this may be the spherical straight-line distance between the professional and the provider. In another embodiment, this may be the actual driving distance, which may be calculated using services such as MAPQUEST. Any workers who have indicated a maximum distance (or time) greater than the calculated distance (or time) are removed from consideration.

A skill match may also be used to identify and/or eliminate workers from consideration. In one embodiment, in calculating a skills match, equal weight is given to the skill type and years experience and “last-used” parameters. This results in any worker having the requested skill matching at 50%. To achieve a 100% skill match in this example, the worker would need to have used the skill within some minimum number of years (or months) as indicated by the hiring entity, or have at lease some minimum number of years experience using the requested skill. In one embodiment, any worker having the requested skill is included in the population of potential workers, even though the “years experience” and “last-used” parameters are used to calculate the skill match. One example of a skill match calculation is shown below.

$$\begin{matrix}Total Skill Points Possible \text{:} PP = {\sum }_{{Skill}_{0}}^{{Skill}_{i}} i \\ Total Skill Points Earned ( PE ) \text{:} PE = \\ {\sum }_{{Skill}_{0}}^{{Skill}_{i}} ( \begin{matrix}2 * Boolean ( HasSkill ( {Skill}_{i} ) ) + \\ Boolean ( HasExp ( {Skill}_{i} ) >= WantExp ( {Skill}_{i} ) ) + \\ Boolean ( LastUsed ( {Skill}_{i} ) <= WantLastUsed ( {Skill}_{i} ) )\end{matrix} ) \\ Final Skills Score = Match Score = \frac{PE}{PP}\end{matrix}$$

In embodiments in which certain skills are mandatory and others preferred or optional, the calculation may be run twice—once for mandatory skills and again for preferred skills. The results may be combined accordingly:

$$\begin{matrix}Mandatory Score = Match Score ( all mandatory skills ) \\ Preferred Score = Match Score ( all preferred skills ) \\ Final Skills Score = Composite Score = \\ \frac{3 ( Mandatory Score ) + ( Preferred Score )}{4}\end{matrix}$$

In some embodiments, an overtime exposure value may be calculated for each worker as, for example, low, moderate, or high. Even though any worker having met the minimum overtime threshold (e.g., worked 40 hours in a week) has her minimum rate adjusted automatically, there are other ways in which the worker may be deemed to be in “overtime.” For example, a worker may have bid on but not yet been awarded several shifts, or a worker may have worked shifts that have not been submitted through the timesheet system. In such instances, an estimated exposure may be calculated according to the formula below:

$$Estimated Exposure = [ \begin{matrix}( Hours Booked ) + ( Ad \text{-} Hoc Hours Submitted ) + \\ ( Hours in Bid ) + ( Hours in Shift )\end{matrix} ]$$

One method of ranking exposure groups workers in to exposure levels based on the results of the estimated exposure calculation. An example of such a grouping is shown below:

| Exposure | Rule |
|---|---|
| Low (0) | Estimated Exposure <=36 Hours |
| Moderate (1) | 40 Hours > Estimated Exposure > 36 Hours |
| High (3) | Estimated Hours >40 Hours |

Invoices and Payroll

In one embodiment, the system may produce periodic provider invoices, settling authorized timesheets for the previous time period (e.g., week, two-week period, month, etc.). Invoices may include such information as identifier of the worker (by handle, SSN, or other ID), the name of the worker, the start date time and end date time of the shift, the shift confirmation number, the amount, any overtime hours, and the overtime charge. An invoice also may include a sum of regular hours charges, a sum of overtime charges, taxes (as applicable) and a sum of all charges.

Likewise, the system may generate information for a payroll system. The payroll information may include information that is typically included (e.g., gross pay, government withholding, benefits withholding, and so on).

In one embodiment, as workers submit their timesheets, a current invoice for the hiring entity accrues. Entities may view the invoice to authorize timecard entries that are accruing, and to view the current invoice. Old invoices may be stored, for example in PDF format, and may be viewed by entities. In some instances, the invoices are mailed (either electronically or using the post) to the entity.

Incident Reports

In one embodiment, the system facilitates the creation, review and adjudication of incident reports for describing events that occur related to a worker, a shift, and/or a hiring entity. If, for example, an entity submits an incident report that involves theft, injury, or any potential felony, administrators may contact the entity to investigate. If the incident is of a serious nature (and in some cases validated) the worker involved may be placed on suspension and/or have his pending shifts re-posted.

In one embodiment, an incident report form includes a brief causal description of the incident (e.g., the worker was the cause of the incident, or someone else was the cause), the category of incident, date and time of the incident, the facility where the event occurred, and a description of the incident, a contact number for the reporter, and an indication of the best time to call. The submitting person and the administrator may be alerted to the filing of an incident.

In one embodiment, workers and hiring entities may alert administrators in the event of a reportable incident. Depending on the incident claim, workers may be proscribed from bidding on new shifts, working shifts to which they've already been booked, or even removed from the system altogether. An administrator may view, audit, and address issues filed through the system. Access to incident reports may be limited to certain administrators. In one embodiment, the system may present a listing of incidents (either pending, closed, or both) such that incidents associated with a particular worker, entity or pairing may be viewed.

Competition Arena

In certain embodiments, users of the employment marketplace may participate in periodic and/or ongoing competitions that, in some cases, may relate to their particular field, or in other cases be of a more general nature. In one embodiment, the competitions include taking one or more exams. The exams may include any number of true/false questions, multiple choice response questions and/or short answer questions. Using the nursing example above, exams comprising questions about particular medications, medical procedures, and general health may be presented to users and prizes awarded based on the results. In some cases, a prize (e.g., money, credits for training, books, work-related equipment and/or other items) may be awarded to the individual that correctly answers the most questions in a given time. In other cases, a series of exams may be presented (e.g., one a week, one a month, etc.) and an ongoing score is maintained for each participant such that the participant with the highest score at the end of the series is awarded a prize. In some cases, multiple exams may be presented simultaneously, whereas in other cases only one exam is administered at a time. Prizes may also be awarded for second and third place, and/or for exceptionally high scores on individual exams (e.g., for getting all the questions correct). In some embodiments, the participants can review practice exams, which, in some cases, may be made up of previously administered exams or questions.

Scoring the exams may be done based on a raw score (e.g., number correct divided by the total number of questions) for each exam or for an entire series of exams. In some cases, scoring takes into account the amount of time a participant spent on a particular question. For example, if a participant correctly answered 30 out of 40 questions, and did so in a total of 65 minutes, her score may be higher than another participant who answered the same number of questions correctly but took 90 minutes to do so. Some questions (and in some cases an entire exam) may include a maximum time limit during which the participant must provide an answer.

In some embodiments, a provisional score is calculated for the participants that is computed based on the percentage of test questions answered correctly by the contestant and a stochastic measure of the time used by the contestant to respond to each question as compared to other participants, based, for example, on the standard deviation of response times. One example of calculating a time-scaled score based on response times is detailed below:
For each question, compute the mean (M) and standard deviation (SD) of response times for all correct responses by every participant for the question
Compute time-scaled score for each user as (M—users response time)/SD
Add a constant C to all time-scaled scores to eliminate negative values
For the entire exam for a user, sum all time-scaled scores for all questions in the exam

In some cases, the time-scaled scores are further scaled to fall within an interval between (0, 100/N), where N is total number of questions on an exam.

Upon completing an exam, the participant may be permitted to “retake” the exam. If the participant chooses to do so, the exam may re-presented in the same sequence as before, or in some cases presented in a different order. Upon completion of the “retake,” the provisional score is recomputed. In such cases, responses from both the initial test and the “retake” may be used in the second computation. For example, a participant who submits 10 correct responses in the first take of an exam made up of 20 questions and 15 correct responses in her second attempt may receive a score of (10+15/20+20), for an overall percentage correct score of 62.5%. Limits may be placed on the number of times a participant may retake a test such that each participant is permitted to retake each active exam a maximum number of times (e.g., twice).

Upon completion of a “retake,” or if no retake is completed, the participant may be presented with her score sheet displaying her provisional score. In some cases, the percentage of questions she answered correctly may also displayed. In some cases, a participant's score may be hidden until they decide whether to retake the exam.

A leader board may be made available for presentation of provisional scores for some or all of the participants, and in some cases may include information about the participants such as their handle, their rating, etc. The participants may be ranked by score, by rating, or some combination thereof. The leader board may be for an individual exam or for a series of exams, and may be updated periodically to include new participants. In some cases, the leader board also displays prize amounts awarded to each participant and/or available to be won for an exam or series of exams.

Public/Community Areas

In one embodiment, the system also includes a public and/or community area to communicate news, marketing, and demonstrations, and allow for the development of an online community for the workers. For example, visitors to the site may be able to view general news, announcements and information about the community, gain a better idea of the demand for their skills and services, and view a list of entities hiring in their area without registering or providing authentication information. In one embodiment, this general content area may be implemented using an off-the-shelf or custom content management system.

In one embodiment, the system may monitor interest in and visits to the site. For example, if the system is deployed to a new states, it may be possible to measure the effectiveness of a direct mail campaign by the volume of workers who actively register their interest and zip code. Such data can then be used to support sales efforts directed to hiring entities. In some implementations, web logs and other such mechanisms may be used to gain a broad picture of activity and interest by geography. The system may also use a reverse DNS lookup facility to determine the location of originating IP addresses. This may be accomplished through selection and configuration of web service software.

In one embodiment, registered workers may participate in online forums in which they can create new discussion threads, respond to posts, and suggest new forums. Workers may elect to receive notification of new posts to a forum, or receive an RSS feed of posts in a particular form. In one embodiment, administrators may create, edit, and delete forums and, if necessary remove specific threads or bar specific users from participating in the forums. In some instances, thw pubic forums may include information about current prices for certain jobs and/or qualification levels, information about certain hiring entities, opportunities for training, etc.

In one embodiment, the system provides HTML or flash-based demonstrations teaching about the use of the web site for users (both workers and hiring managers) that explains the processes described above.

Administration

In one embodiment, administrators may manage and reset passwords. Administrators may create, deactivate, and edit accounts associated with both workers and hiring entities. An administrator may change account information, and may take action on behalf of a user if necessary. In some instances, a user may be notified when changes are made to her account or other information. For example, an administrator may review the worker's information upon registration, and add missing information, or acknowledge receipt of paper copies of documents.

Exemplary Implementation

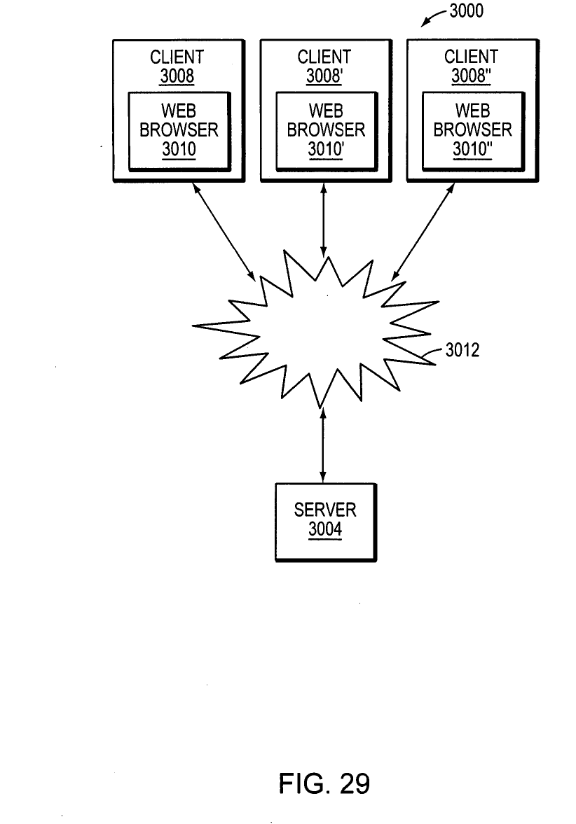

Referring to FIG. 30, in one embodiment, a system 3000 for performing the functions described here includes at least one server 3004, and at least one client 3008, 3008′, 3008″, generally 3008. As shown, production system includes three clients 3008, 3008′, 3008″, but this is only for exemplary purposes, and it is intended that there can be any number of clients 3008. The client 3008 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 3008 could also be implemented on such hardware as a smart or dumb terminal, network computer, wireless device, wireless telephone, information appliance, workstation, minicomputer, mainframe computer, or other computing device that is operated as a general purpose computer or a special purpose hardware device used solely for serving as a client 3008 in the staffing and rating system.

Generally, in some embodiments, clients 3008 can be operated and used by participants to participate in various staffing and rating activities. For example, the clients may be operated by workers and hiring entities to accomplish the tasks described here. Clients 3008 may also be operated by administrators, to manage the functions of the system, as described above.

In various embodiments, the client computer 3008 includes a web browser 916. The web browser 3010 allows the client 3008 to request a web page or other downloadable program, applet, or document (e.g., from the server 3004) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 3008 manually requests a web page from the server 3004. Alternatively, the client 3008 automatically makes requests with the web browser 3010. Examples of commercially available web browser software 3010 are INTERNET EXPLORER, offered by Microsoft Corporation, NETSCAPE NAVIGATOR, offered by AOL/Time Warner, or FIREFOX offered the Mozilla Foundation.

A communications network 3012 connects the client 3008 with the server 3004. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 3012 can carry TCP/IP protocol communications, and HTTP/HTTPS requests made by the web browser 3010 to the server 3004. The type of network is not a limitation, however, and any suitable network may be used. Non-limiting examples of networks that can serve as or be part of the communications network 3012 include a wireless or wired Ethernet-based intranet, a local or wide-area network (LAN or WAN), and/or the global communications network known as the Internet, which may accommodate many different communications media and protocols.

The servers 3004 interact with clients 3008. The server 3004 is preferably implemented on one or more server class computers that have sufficient memory, data storage, and processing power and that run a server class operating system (e.g., SUN Solaris, GNU/Linux, and the MICROSOFT WINDOWS family of operating systems). In one embodiment, off-the-shelf web server (e.g., Apache), application server (e.g., JBoss, Websphere), and database server software is used in combination with code specific to the functions described here. Other types of system hardware and software than that described herein may also be used, depending on the capacity of the device and the number of users and the size of the user base. For example, the server 3004 may be or may be part of a logical group of one or more servers such as a server farm or server network. As another example, there could be multiple servers 3004 that may be associated or connected with each other, or multiple servers could operate independently, but with shared data. In a further embodiment and as is typical in large-scale systems, application software could be implemented in components, with different components running on different server computers, on the same server, or some combination.

The server includes or has access to a computer readable medium, with instructions for implementing the functions described here. The software used to implement the system may include modules and submodules to perform the various tasks described.

While the invention has been particularly shown and described with reference to specific embodiments, it should be understood by those skilled in the area that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for providing workers to fulfill staffing requests, the method comprising:
receiving availability information from a worker, the worker having a first reliability rating and a first professionalism rating;
generating a first composite rating from the first reliability rating and the first professionalism rating;
receiving a shift staffing request from a hiring entity;
matching the worker's availability with the hiring entity's shift staffing request using the first composite rating;
receiving an evaluation of the worker from the hiring entity;
generating a second reliability rating for the worker in response to the evaluation and the first reliability rating;
generating a second professionalism rating in response to the evaluation and the first professionalism rating; and
generating a second composite rating for the worker in response to the second professionalism rating and the second reliability rating.

2. The method of claim 1 wherein the availability information comprises one or more of a date available, a day of the week available, a time available, a preferred geographic location, and a minimum travel distance.

3. The method of claim 1 further comprising receiving registration information from the worker.

4. The method of claim 3 wherein the registration information comprises licensure information.

5. The method of claim 3 wherein the registration information comprises skills information.

6. The method of claim 5 wherein matching the worker's availability with the hiring entity's shift staffing request is based at least in part on the skill information.

7. The method of claim 1 further comprising screening the workers prior to accepting the availability information.

8. The method of claim 6 wherein screening the workers comprises administering one or more tests.

9. The method of claim 8 wherein the one or more tests comprise questions relating to skills required to fulfill the shift requests.

10. The method of claim 8 wherein matching the worker's availability with the hiring entity's shift staffing request is based at least in part on results of the one or more tests.

11. The method of claim 1 further comprising receiving timesheet information from the worker.

12. The method of claim 11 wherein the reliability rating is based at least in part on the timesheet information received from the worker.

13. The method of claim 11 further receiving an approval of the timesheet information from the hiring entity.

14. The method of claim 1 wherein the hiring entity comprises a healthcare facility and the worker is a healthcare professional.

15. The method of claim 1 further comprising receiving an appeal of the evaluation from the worker.

16. The method of claim 1 further comprising receiving a preferred list of hiring entities from the worker.

17. The method of claim 1 further comprising receiving a blacklist of hiring entities from the worker.

18. The method of claim 1 further comprising receiving a preferred list of workers from the hiring entity.

19. The method of claim 1 further comprising receiving a blacklist of workers from the hiring entity.
